(19) United States
(12) Patent Application Publication
(10) Pub. No.: US 2009/0136848 A1
(43) Pub. Date: May 28, 2009

(54) NON-AQUEOUS ELECTROLYTE BATTERY AND METHOD OF MANUFACTURING THE SAME

(75) Inventors: Hiroshi Minami, Moriguchi-shi (JP); Takeshi Ogasawara, Moriguchi-shi (JP); Naoki Imachi, Moriguchi-shi (JP); Atsushi Kaiduka, Moriguchi-shi (JP); Yasunori Baba, Moriguchi-shi (JP); Yoshinori Kida, Moriguchi-shi (JP); Shin Fujitani, Moriguchi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi, Osaka (JP)

(21) Appl. No.: 12/293,399

(22) PCT Filed: Mar. 16, 2007
(86) PCT No.: PCT/JP2007/055446

§ 371 Date: Jan. 12, 2009

(30) Foreign Application Priority Data
Mar. 17, 2006 (JP) 2006-074554
Mar. 17, 2006 (JP) 2006-074555
Mar. 17, 2006 (JP) 2006-074556
Jun. 21, 2006 (JP) 2006-171450
Jul. 31, 2006 (JP) 2006-207450
Jul. 31, 2006 (JP) 2006-207451

(51) Int. Cl. H01M 4/50; B05D 5/12

(52) U.S. Cl. 429/224; 429/231.95; 427/58

(57) ABSTRACT

[Problem] A non-aqueous electrolyte battery is provided that shows good cycle performance and good storage performance under high temperature conditions and exhibits high reliability even with a battery configuration featuring high capacity. A method of manufacturing the battery is also provided.

[Means for Solving the Problem] A non-aqueous electrolyte battery is characterized in that the positive electrode active material contains at least cobalt or manganese, the separator includes a porous separator main body and a coating layer formed on at least one surface of the separator main body, and the coating layer contains filler particles and a water-insoluble binder.

### TECHNICAL FIELD

The present invention relates to improvements in non-aqueous electrolyte batteries, such as lithium-ion batteries and polymer batteries, and methods of manufacturing the batteries. More particularly, the invention relates to, for example, a battery structure that is excellent in cycle performance and storage performance at high temperature and that exhibits high reliability even with a high-capacity battery configuration.

### BACKGROUND ART

Mobile information terminal devices such as mobile telephones, notebook computers, and PDAs have become smaller and lighter at a rapid pace in recent years. This has led to a demand for higher capacity batteries as the drive power source for the mobile information terminal devices. With their high energy density and high capacity, lithium-ion batteries that perform charge and discharge by transferring lithium ions between the positive and negative electrodes have been widely used as the driving power sources for the mobile information terminal devices.

The mobile information terminal devices tend to have higher power consumption as the functions of the devices, such as moving picture playing functions and gaming functions. It is strongly desired that the lithium-ion batteries that are the drive power source for the devices have further higher capacities and higher performance in order to achieve longer battery life and improved output power.

Under these circumstances, the research and development efforts to provide lithium-ion batteries with higher capacities have been underway, which center around the attempts to reduce the thickness of the components that are not involved in the power generating element, such as battery cans, separators, and positive and negative electrode current collectors (e.g., aluminum foils or copper foils), as well as the attempts to increase the filling density of active materials (i.e., improvements in electrode filling density). These techniques, however, seem to be approaching their limits, and fundamental improvements such as finding alternative materials have become necessary to achieve a greater capacity in lithium-ion batteries. Nevertheless, regarding the attempts to increase the battery capacity through alternative positive and negative electrode active materials, there are few candidate materials for positive electrode active materials that are comparable or superior to the state-of-the-art lithium cobalt oxide in terms of capacity and performance, although alloy-based negative electrodes with Si, Sn, etc. appear to be promising as negative electrode active materials.

In this situation, we have developed a battery that can achieve an increased capacity by raising the end-of-charge voltage of the battery that employ lithium cobalt oxide as the positive electrode active material, from the currently common 4.2 V to a higher region to increase the utilization depth (charge depth). The reason why such an increase in the utilization depth can achieve a higher battery capacity may be briefly explained as follows. The theoretical capacity of lithium cobalt oxide is about 273 mAh/g, but the battery rated at 4.2 V (the battery with an end-of-charge voltage of 4.2 V) utilizes only up to about 160 mAh/g, which means that it is possible to increase the battery capacity up to about 200 mAh/g by raising the end-of-charge voltage to 4.4 V. Raising the end-of-charge voltage to 4.4 V in this way accomplishes about 10% increase in the overall battery capacity.

When lithium cobalt oxide is used at a high voltage as described above, the oxidation power of the charged positive electrode active material increases. Consequently, the decomposition of the electrolyte solution is accelerated, and moreover, the delithiated positive electrode active material itself loses the stability of the crystal structure. Accordingly, most important issues to be resolved have been the cycle life deterioration and the performance deterioration during storage due to the crystal disintegration. We have already found that addition of zirconia, aluminum, or magnesium to lithium cobalt oxide can achieve comparable performance to the 4.2 V battery even at a higher voltage under room temperature conditions. However, as recent mobile devices require higher power consumption, it is essential to ensure battery performance under high-temperature operating conditions so that the battery can withstand continuous operations in high temperature environments. For this reason, there is an imminent need to develop the technology that can ensure sufficient battery reliability even under high temperature conditions, not just under room temperature conditions.

[Patent Reference 1] Japanese Published Unexamined Patent Application No. 2002-141042

### DISCLOSURE OF THE INVENTION

### Problems to be Solved by the Invention

It has been found that the positive electrode of the battery with an elevated end-of-charge voltage loses the stability of the crystal structure and shows a considerable battery performance deterioration especially at high temperature. Although the details have not yet been clear, there are indications of decomposition products of the electrolyte solution and dissolved elements from the positive electrode active material (dissolved cobalt in the case of using lithium cobalt oxide) as far as we can see from the results of an analysis, and it is believed that these are the primary causes of the deteriorations in cycle performance and storage characteristics under high temperature conditions.

In particular, in the battery system that employs a positive electrode active material composed of lithium cobalt oxide, lithium manganese oxide, lithium-nickel-cobalt-manganese composite oxide, or the like, high temperature storage causes the following problems. When stored at high temperature, cobalt or manganese dissociates into ions and dissolves away from the positive electrode, and subsequently, these elements deposit on the negative electrode and the separator as they are reduced at the negative electrode. This results in an increase in the battery internal resistance and the resulting capacity deterioration. Furthermore, when the end-of-charge voltage of the lithium-ion battery is raised as described above, the instability of the crystal structure is worsened, and the foregoing problems are exacerbated, so the foregoing phenomena tend to occur even at a temperature of about 50° C., where the battery rated at 4.2 V have not caused the problems. Moreover, these problems tend to worsen when a separator with a small film thickness and a low porosity is used.

For example, with a battery rated at 4.4 V that uses a lithium cobalt oxide positive electrode active material and a graphite negative electrode active material, a storage test (test conditions: end-of-charge voltage 4.4 V, storage temperature 60° C., storage duration 5 days) shows that the remaining capacity after the storage deteriorates considerably, in some cases as low as about zero. Following the disassembly of the tested battery, a large amount of cobalt was found in the negative electrode and the separator. Therefore, it is believed that the elemental cobalt that has dissolved away from the positive electrode accelerated the deterioration. The valency of the positive electrode active material that has a layered structure, such as lithium cobalt oxide, increases by the extraction of lithium ions. However, since tetravalent cobalt is unstable, the crystal structure thereof is unstable and tends to change into a more stable structure. This is believed to cause the cobalt ions to easily dissolve away from the crystals. It is also known that when a spinel-type lithium manganese oxide is used as the positive electrode active material as well, trivalent manganese becomes non-uniform, and dissolves away from the positive electrode as bivalent ions, causing the same problems as in the case of using lithium cobalt oxide as the positive electrode active material.

As described above, when the charged positive electrode active material has an unstable structure, the performance deterioration during storage and the cycle life degradation under high temperature conditions tend to be more evident. It is also known that this tendency is more evident when the filling density of the positive electrode active material layer is higher, so the problems are more serious in a battery with a high capacity design. It should be noted that even the physical properties of the separator, not just the negative electrode, are involved because, for example, by-products of the reactions produced from the positive and negative electrodes migrate through the separator to the opposite electrodes, further causing secondary reactions. Thus, it is believed that the ion mobility and migration distance within the separator are involved greatly.

To overcome such problems, attempts have been made to prevent cobalt or the like from dissolving away from the positive electrode by, for example, physically coating the surface of the positive electrode active material particles with an inorganic substance, or by chemically coating the surface of the positive electrode active material particles with an organic substance. However, in the case of the physical coating, since the positive electrode active material more or less expands and shrinks repeatedly during charge-discharge cycling, the advantageous effect resulting from the coating may be lost. On the other hand, in the case of the chemical coating, it is difficult to control the thickness of the coating film. If the thickness of the coating layer is too large, the internal resistance of the battery increases, making it difficult to attain desired performance, and as a result, the battery capacity reduces. Moreover, there remains an issue that it is difficult to coat the entire particle, limiting the advantageous effect resulting from the coating. Thus, there is a need for an alternative technique to the coating methods.

Accordingly, it is an object of the present invention to provide a non-aqueous electrolyte battery that shows good cycle performance and good storage performance under high temperature conditions, and exhibits high reliability even with a battery configuration featuring high capacity.

### Means for Solving the Problems

In order to accomplish the foregoing and other objects, the present invention provides a non-aqueous electrolyte battery comprising: a positive electrode having a positive electrode active material layer containing a positive electrode active material; a negative electrode having a negative electrode active material; a separator interposed between the positive electrode and the negative electrode; an electrode assembly comprising the positive electrode, the negative electrode, and the separator; and a non-aqueous electrolyte impregnated in the electrode assembly, characterized in that: the positive electrode active material contains at least cobalt or manganese; and the separator comprises a porous separator main body and a coating layer formed on at least one surface of the separator main body, the coating layer comprising filler particles and a water-insoluble binder.

In the above-described configuration, the water-insoluble binder contained in the coating layer, which is disposed on the surface of the separator main body, absorbs the electrolyte solution and expands, and as a result, the expanded water-insoluble binder fills up the gaps between the filler particles to an appropriate degree, enabling the coating layer containing the filler particles and the water-insoluble binder to exhibit an appropriate level of filtering function. Thus, the coating layer traps the decomposition product of the electrolyte solution resulting from the reaction at the positive electrode as well as the cobalt ions or manganese ions dissolved away from the positive electrode active material, preventing the cobalt or manganese from depositing on the negative electrode and/or the separator. This makes it possible to alleviate damages to the negative electrode and the separator. Therefore, the deterioration in the cycle performance under high temperature conditions and the deterioration in the storage performance under high temperature conditions can be lessened. Moreover, the water-insoluble binder firmly bonds the filler particles to one another, as well as the coating layer to the separator main body, preventing the coating layer from coming off from the separator main body. Thus, the above-described advantageous effect is maintained for a long period.

Moreover, when the water-insoluble binder is used, the dispersion capability of the filler particles can be ensured by merely mixing the water-insoluble binder, the filler particles, and the organic solvent together, and therefore, the coating layer can be formed easily.

It is desirable that the concentration of the water-insoluble binder be 50 mass % or less with respect to the filler particles, more desirably 10 mass % or less, and still more desirably 5 mass % or less.

The reason is that if the concentration of the water-insoluble binder is excessively high, mobility of lithium ions reduces extremely and the resistance between the electrodes increases, resulting in deterioration of the charge-discharge capacity.

It is desirable that the water-insoluble binder comprise a copolymer containing an acrylonitrile unit and/or a polyacrylic acid derivative.

The reason is as follows. The copolymer containing an acrylonitrile unit and the like can fill the gaps between the filler particles by swelling after absorbing the electrolyte solution. Moreover they have high binding strength with the filler particles, and also they can ensure the dispersion capability of the filler particles sufficiently so as to prevent the re-aggregation of the filler particles. Furthermore, they have such a characteristic that they only dissolve into the non-aqueous electrolyte in a small amount. Therefore, they have sufficient functions required for the binder.

It is desirable that the coating layer be formed on a surface of a positive electrode side of the separator main body.

When the coating layer is formed on the surface of the positive electrode side of the separator main body, the coating layer traps the decomposition products of the electrolyte solution reacting with the positive electrode and the cobalt ions and manganese ions dissolving away from the positive electrode active material immediately (before they move to the separator), so the above-described advantageous effect can be exerted further.

It is desirable that the coating layer contain a water-soluble binder, and the coating layer be formed on a surface of a negative electrode side of the separator main body.

In a non-aqueous electrolyte battery, by its nature, it is essential that the separator have a current shut-off mechanism (what is called a shutdown mechanism) by clogging the micropores in order to ensure safety. This mechanism utilizes the melting point of the separator (for example, polyethylene). Therefore, that function may be impaired if the separator is heated to a higher temperature than a predetermined temperature when forming the coating layer.

Here, as described above, it is possible to use only a water-insoluble binder such as PVDF or an acrylic polymer as the binder (binder agent) when forming the coating layer. However, when only such a water-insoluble binder is used, NMP (N-methyl pyrrolidone), which has a boiling point of 200° C. or higher, is commonly used as the solvent. As a consequence, a problem may arise that the separator shrinks in the removing and drying step of the solvent. In view of the problem, it is possible to use an alcohol-based solvent with a relatively low boiling point, such as a general purpose solvent like L-solve (made by Kishida Chemical Co., Ltd.), cyclopentanone, and the like. However, these solvents are inflammable and difficult in handling since, for example, there is a restriction on the amount that can be stored, so high equipment costs are required.

On the other hand, when a water-soluble binder and a water-insoluble binder are mixed and dispersed in water as the solvent as described above, there are less adverse effects on the physical properties of the separator (such as shrinkage) since the drying temperature of water is relatively low. Moreover, water is very easy to handle and requires a minimum equipment cost. Therefore, the manufacturing costs of the battery can be reduced. Furthermore, the water-insoluble binder dispersed in water exists in the form of emulsion, so the bonding pattern is not such that the entire filler particle is covered, but it is more like spot gluing (the contact area is small). Accordingly, it is desirable also from the viewpoint that appropriate flexibility and bonding strength can be ensured with a small amount.

However, if the coating layer is disposed on the positive electrode side in a battery employing the separator having such a coating layer, the binder and the like contained in the coating layer may decompose by the highly oxidizing atmosphere originating from the positive electrode in the case that the battery is stored at a high temperature or the charge depth is increased, resulting in a considerable degradation in the battery performance. For this reason, it is necessary to dispose the coating layer on the negative electrode side in a battery employing the separator having the above-described coating layer.

It is preferable that the water-insoluble binder comprise a fluorine-free polymer, and the water-soluble binder comprise at least one substance selected from the group consisting of a cellulose-based polymer, an ammonium salt thereof, an alkali metal salt thereof, a polyacrylic acid ammonium salt thereof, and a polycarboxylic acid ammonium salt thereof.

When the water-insoluble binder comprises a fluorine-free polymer, good binding strength and flexibility can be achieved even with a small amount. When the water-soluble binder comprises a cellulose-based polymer or the like, sufficient dispersion capability can be exerted.

It is desirable that the coating layer contain surfactant.

Currently, polyethylene (PE) is used as the separator, and polyethylene is water repellent. For this reason, it is desirable that a surfactant for exerting a surface activation effect be added to the coating layer. However, when a non-water-repellent material is used as the separator or when a material for exerting a surface activation effect is used as the binder, the addition of the surfactant is unnecessary.

It is desirable that the concentration of the water-insoluble binder be 10 mass % or less with respect to the total amount of solid content, more desirably 5 mass % or less, and still more desirably 3 mass % or less.

The reason is that if the concentration of the water-insoluble binder is excessively high, mobility of lithium ions reduces extremely and the resistance between the electrodes increases, resulting in deterioration of the charge-discharge capacity. It should be noted that the term “solid content” is intended to include the filler particles, the water-insoluble binder, and the water-soluble binder, and that when the binder contains a surfactant, it also includes the surfactant.

In addition, for the same reason as above, it is desirable that the total amount of solid content excluding the filler particles is 30 mass % or less with respect to the amount of the filler particles.

It is desirable that the product of x and y, where x (μm) is the thickness of the separator main body and y (%) is the porosity of the separator main body, be 1500 (μm·%) or less.

The reason is as follows. A separator main body with a smaller pore volume is more susceptible to the adverse effects originating from the deposition product and the side reaction product, resulting in more significant performance degradation. Thus, by applying the present invention to the battery having such a separator main body as described above, a more significant advantageous effect can be obtained.

It is preferable that the product of x and y be controlled to be 800 (μm·%) or less.

A battery that uses such a separator main body is more susceptible to the performance deterioration. Therefore, the present invention can be more effective when applied to the battery that uses such a separator main body.

It should be noted that such a battery may also achieve an improvement in the energy density because such a battery accomplishes a separator thickness reduction.

It is preferable that the filler particles comprise inorganic particles. In particular, it is desirable that the inorganic particles be made of a rutile-type titania and/or alumina.

The reason why the filler particles are restricted to inorganic particles, particularly to rutile-type titania and/or alumina, is that these materials show good stability within the battery (i.e., have low reactivity with lithium) and moreover they are low cost materials. The reason why the rutile-type titania is employed is as follows. The anatase-type titania is capable of insertion and deinsertion of lithium ions, and therefore it can absorb lithium and exhibit electron conductivity, depending on the surrounding atmosphere and or the potential, so there is a risk of capacity degradation and short circuiting.

However, since the type of the filler particles has very small impact on the advantageous effects of the invention, it is also possible to use, in addition to the above-mentioned substances, filler particles made of other substances such as zirconia and magnesia, and sub-micron particles made of an organic substance, such as polyimide, polyamide, or polyethylene.

It is desirable that the filler particles have an average particle size greater than the average pore size of the separator main body.

If the filler particles have an average particle size smaller than the average pore size of the separator main body, the separator main body may be pierced in some portions when winding and pressing the electrode assembly during the fabrication of the battery, and consequently the separator main body may be damaged considerably. Moreover, the filler particles may enter the pores of the separator main body and degrade various characteristics of the battery. To avoid such problems, the average particle size of the filler particles should be controlled as described above.

It is preferable that the filler particles have an average particle size of 1 μm or less. In addition, taking the dispersion capability of the slurry into consideration, it is preferable to use inorganic particles subjected to a surface treatment with aluminum, silicon, or titanium.

It is desirable that the coating layer have a thickness of 4 μm or less, more desirably 2 μm or less.

Although the above-described advantageous effects become more significant when the thickness of the coating layer is larger, an excessively large thickness of the coating layer is problematic. If the thickness of the coating layer is too large, load characteristics may degrade because of an increase in the internal resistance of the battery, and the battery energy density may also decrease because an excessively large thickness of the coating layer means less amounts of the active materials in the positive and negative electrodes. For that reason, it is desirable that the coating layer have a thickness of 4 μm or less, particularly desirably 2 μm or less. It should be noted that the trapping effect is sufficiently obtained even when the thickness of the coating layer is small because the coating layer has a complicated, complex structure. It should be noted that when the coating layer is formed on only one side of the separator, the thickness of the coating layer means the thickness of that layer, while when the coating layer is formed on both sides of the separator, the thickness of the coating layer means the thickness of the coating layer on one side.

It is desirable that the positive electrode active material layer have a filling density of 3.40 g/cc or greater.

The reason is as follows. When the filling density is less than 3.40 g/cc, the reaction in the positive electrode takes place over the entire electrode, not locally. Therefore, the deterioration of the positive electrode also proceeds uniformly and does not significantly affect the charge-discharge reactions after storage. On the other hand, when the filling density is 3.40 g/cc or higher, the reaction in the positive electrode is limited to local reactions in the outermost surface layer, and the deterioration of the positive electrode also mainly takes place in the outermost surface layer. This means that the intrusion and diffusion of lithium ions into the positive electrode active material during discharge become the rate-determining processes, and therefore, the degree of the deterioration becomes large. Thus, the advantageous effects of the present invention are sufficiently exhibited when the positive electrode active material layer has a filling density of 3.40 g/cc or greater.

It is desirable to employ a configuration in which the positive electrode is charged to 4.30 V or higher, more preferably 4.40 V or higher, and particularly preferably 4.45 V or higher, versus a lithium reference electrode potential.

The reason is as follows. The presence or absence of the coating layer does not make much difference in high temperature performance of a battery in which the positive electrode is configured to be charged to less than 4.30 V versus a lithium reference electrode potential, but the presence or absence of the coating layer leads to a significant difference in high temperature performance of a battery in which the positive electrode is charged to 4.30 V or higher versus a lithium reference electrode potential. In particular, this difference emerges especially noticeably in a battery in which the positive electrode is charged to 4.40 V or higher or to 4.45 V or higher.

It is desirable that the positive electrode active material contain lithium cobalt oxide containing at least aluminum or magnesium in solid solution, and zirconia being in electrical contact with the lithium cobalt oxide be firmly adhered to the surface of the lithium cobalt oxide.

The reason for employing such a configuration is as follows. In the case of using lithium cobalt oxide as the positive electrode active material, as the charge depth increases, the crystal structure becomes more unstable and the deterioration accelerates in a high temperature atmosphere. In view of this problem, aluminum or magnesium is contained in the positive electrode active material (inside the crystals) in the form of solid solution so that crystal strain in the positive electrode can be alleviated. Although these elements serve to stabilize the crystal structure greatly, they may lead to poor initial charge-discharge efficiency and poor discharge working voltage. In order to alleviate this problem, zirconia being in electrical contact with the lithium cobalt oxide is adhered firmly to the surface of the lithium cobalt oxide.

Further, it is preferable that the invention be applied to a battery that may be used in an atmosphere at 50° C. or higher.

The advantageous effects resulting from the present invention will be greater because the deterioration of the battery accelerates when used under an atmosphere at 50° C. or higher.

In order to accomplish the foregoing and other objects, the present invention provides a non-aqueous electrolyte battery comprising: a positive electrode having a positive electrode active material layer containing a positive electrode active material; a negative electrode; a separator interposed between the positive electrode and the negative electrode; an electrode assembly comprising the positive electrode, the negative electrode, and the separator; and a non-aqueous electrolyte comprising a solvent and a lithium salt, the non-aqueous electrolyte being impregnated in the electrode assembly, characterized in that: the positive electrode active material contains at least cobalt or manganese; a coating layer containing inorganic particles and a binder is formed on a surface of a positive electrode side of the separator and/or on a surface of a negative electrode side of the separator; the lithium salt comprises LiBF₄; and the positive electrode is charged to 4.40 V or higher versus a lithium reference electrode potential.

When the electrolyte solution contains LiBF₄ as described above, a surface film originating from the LiBF₄ is formed on the surface of the positive electrode active material, and the presence of the surface film serves to hinder dissolution of the substances constituting the positive electrode active material (such as cobalt ions or manganese ions) and decomposition of the electrolyte solution on the positive electrode surface. As a result, the cobalt ions, the manganese ions, or the decomposition products of the electrolyte solution are hindered from depositing on the negative electrode surface.

Nevertheless, it is difficult to cover the positive electrode active material completely with the surface film originating from LiBF₄, so it is difficult to prevent the dissolution of the substances constituting the positive electrode active material and the decomposition of the electrolyte solution on the positive electrode surface sufficiently. In view of this, the coating layer is formed on the surface of the positive electrode side of the separator and/or the surface of the negative electrode side of the separator. Thereby, the cobalt ions etc. and the decomposition products on the positive electrode are trapped by the coating layer, so it is possible to impede these substances from migrating to the separator and the negative electrode and causing deposition reaction (deterioration) and from causing the separator to be clogged. In other words, the coating layer exerts a filtering function, preventing the cobalt or the like from depositing on the negative electrode or the separator. Thereby, the storage performance in a charged state can be prevented from degrading to a sufficient degree.

It is believed that the coating layer exhibits the filtering function for the following reason. The binder contained in the coating layer absorbs the electrolyte solution and swells, and as a result, the swollen binder fills up the gaps between the inorganic particles to an appropriate degree. In addition, it is believed that a complicated and complex filter layer is formed since a plurality of inorganic particles is entangled in the formed layer, so the physical trapping effect is also enhanced.

In addition, the following is the reason why the positive electrode should be charged to 4.40 V or higher versus a lithium reference electrode potential. As described above, LiBF₄ has the advantage of forming a surface film on the positive electrode surface and thereby hindering, for example, dissolution substances from the positive electrode active material and decomposition of the electrolyte solution. Nevertheless, LiBF₄ has a drawback of reducing the concentration of the lithium salt and reducing the conductivity of the electrolyte solution because LiBF₄ is highly reactive with the positive electrode. As a result, when LiBF₄ is added even in the case that the positive electrode is charged to less than 4.40 V versus a lithium reference electrode potential (i.e., when the structure of the positive electrode is not under so much load), the just-mentioned drawback resulting from the addition of LiBF₄ is rather evident, and the battery performance becomes rather poor.

Moreover, the above-described configuration also has the effect of hindering the inorganic particles from being detached over a long period of time since the inorganic particles are firmly bonded to each other by the binder.

In the case of a battery in which LiBF₄ is not contained in the lithium salt and no coating layer is formed, a behavior was confirmed that the charge curve meanders at the time of recharge of the battery after storage and the amount of charge increases significantly when the positive electrode is charged to 4.40 V or higher versus a lithium reference electrode potential. However, it has been confirmed that the configuration according to the present invention has the effect of eliminating such an abnormal charge behavior.

It should be noted that although a prior art example in which LiBF₄ is added to the electrolyte solution has been disclosed (WO2006/54604), it will be clear from the foregoing discussion that merely adding LiBF₄ to the electrolyte solution does not achieve the advantageous effects of the present invention.

It is desirable that the coating layer be formed over an entire surface of the positive electrode side of the separator and/or an entire surface of the negative electrode side of the separator.

Such a configuration makes it possible to exert the effect of trapping cobalt ions and manganese ions in the coating layer, so it is possible to lessen the deterioration in the cycle performance under high temperature conditions and the deterioration in the storage performance under high temperature conditions further.

It is desirable that the amount of the LiBF₄ be from 0.1 mass % to 5.0 mass % with respect to the total amount of the non-aqueous electrolyte.

If the amount of the LiBF₄ is less than 0.1 mass % with respect to the total amount of the non-aqueous electrolyte, the effect of improving the storage performance cannot be exhibited sufficiently because the amount of the LiBF₄ is too small. On the other hand, if the amount of the LiBF₄ exceeds 5.0 mass % with respect to the total amount of the non-aqueous electrolyte, the discharge capacity and deterioration of the discharge load characteristics deteriorate considerably because of side reactions of LiBF₄.

It is desirable that the lithium salt comprise LiPF₆, and the concentration of the LiPF₆ be from 0.6 mole/liter to 2.0 mole/liter.

The LiBF₄ is consumed by the reactions during charge and discharge, so if the electrolyte is LiBF₄ alone, sufficient conductivity cannot be ensured and discharge load characteristics may be deteriorated. For this reason, it is desirable that the lithium salt comprise LiPF₆. In addition, if the concentration of LiPF₆ is too low even when the lithium salt comprises LiPF₆, the same problems as described above arise. Therefore, it is preferable that the concentration of LiPF₆ be 0.6 mole/liter or higher. It also should be noted if the concentration of LiPF₆ exceeds 2.0 mole/liter, the viscosity of the electrolyte solution becomes high, degrading circulation of the electrolyte solution in the battery.

It is desirable that the inorganic particles be made of a rutile-type titania and/or alumina.

The reason is the same as that discussed above. As discussed above, the inorganic particles may be inorganic particles of such as zirconia and magnesia, in addition to those mentioned above.

It is desirable that the inorganic particles have an average particle size greater than the average pore size of the separator.

The reason why such a restriction is made is the same as described above. In addition, it is also preferable that the inorganic particles have an average particle size of 1 μm or less, and taking the dispersion capability of the slurry into consideration, it is preferable to use inorganic particles subjected to a surface treatment with aluminum, silicon, or titanium, as already described above.

It is desirable that the coating layer have a thickness of 4 μm or less.

The reason why such a range is preferable is the same as that discussed above. Likewise, it is also particularly desirable, as described above, that the coating layer have a thickness of 2 μm or less.

It should be noted here that the trapping effect is sufficiently obtained even when the thickness of the coating layer is small because the coating layer has a complicated, complex structure. The thickness of the coating layer may be made smaller without problems than in the case that the coating layer alone is provided (in the case that no LiBF₄ is added) because LiBF₄ is added to the electrolyte solution as described above and a surface film originating from the LiBF₄ is formed on the surface of the positive electrode active material, which hinders dissolution of the substances constituting the positive electrode active material (such as cobalt ions or manganese ions) and decomposition of the electrolyte solution on the positive electrode surface. Taking these things into consideration, it is sufficient that coating layer has a thickness of 1 μm or greater.

For the above reasons, it is desirable that the thickness of the coating layer be from 1 μm to 4 μm, more desirably from 1 μm to 2 μm. It should be noted that the thickness of the above-mentioned coating layer means the thickness of the coating layer on one side.

It is desirable that the concentration of the binder be 50 mass % or less with respect to the inorganic particles.

The upper limit is restricted to such a value for the same reason as described above. Taking such a reason into consideration, it is desirable that that the concentration of the binder be 10 mass % or less with respect to the inorganic microparticles, more desirably 5 mass % or less.

It is desirable that the positive electrode active material layer have a filling density of 3.40 g/cc or greater.

The reason why such a restriction is made is the same as described above.

It is desirable to employ a configuration in which the positive electrode is charged to 4.45 V or higher, more preferably 4.50 V or higher, versus a lithium reference electrode potential.

The reason is that whether or not LiBF₄ is added and whether or not the coating layer is provided leads to a significant difference in high-temperature performance in the case of such a battery in which the positive electrode is charged at 4.45 V or higher versus a lithium reference electrode potential. In particular, this difference emerges especially noticeably in such a battery in which the positive electrode is charged to 4.50 V or higher.

It is desirable that the positive electrode active material contain lithium cobalt oxide containing aluminum or magnesium in solid solution, and zirconia is firmly adhered to the surface of the lithium cobalt oxide.

The reason why it is preferable to employ such a configuration is the same as that discussed above.

Further, it is preferable that the invention be applied to a battery that may be used in an atmosphere at 50° C. or higher.

The advantageous effects resulting from the present invention will be greater because the deterioration of the battery accelerates when used under an atmosphere at 50° C. or higher.

It is desirable that the invention be applied to a battery in which the product of separator thickness x (μm) and separator porosity y (%) is controlled to 800 (μm·%) or less.

The separator pore volume is controlled to 800 (μm·%) or less for the same reason as described above.

However, when the separator pore volume is 1500 (μm·%) or less, the above-described advantageous effects are exhibited sufficiently, and even when the separator pore volume is 1500 (μm·%) or greater, the advantageous effects may be exhibited.

It should be noted that a battery with a small separator pore volume may also achieve an improvement in battery energy density because such a battery can accomplish a separator thickness reduction.

In order to accomplish the foregoing and other objects, the present invention also provides a method of manufacturing a non-aqueous electrolyte battery, comprising the steps of: preparing a separator by coating a slurry containing filler particles, a water-insoluble binder, and an organic solvent onto at least one surface of a porous separator main body and drying the slurry to form a coating layer on the surface; preparing an electrode assembly by interposing the separator between a positive electrode and a negative electrode, the positive electrode having a positive electrode active material containing at least lithium and either cobalt or manganese, and the negative electrode having a negative electrode active material; and impregnating the electrode assembly with a non-aqueous electrolyte.

Such a manufacturing method makes it possible to manufacture a non-aqueous electrolyte battery that uses a water-insoluble binder alone as the binder when forming the coating layer of the separator.

It is desirable that, in the step of preparing the separator, the coating layer be formed by dip coating.

Possible methods of coating include dip coating, gravure coating, die coating, and transfer coating, but by the methods other than the dip coating, the slurry needs to be coated one side of the separator main body at a time. However, when one side thereof is coated with the slurry, the slurry can infiltrate to the other side since the separator main body is a microporous film, so the concentration of the water-insoluble binder in the coating layer may reduce. As a consequence, the advantageous effects of the water-insoluble binder may not be obtained sufficiently in the coating layer. Moreover, the concentration of the water-insoluble binder increases in the separator main body, which may cause problems such as degradation in the air permeability of the separator main body. In order to avoid such problems, it is desirable to adopt the dip coating.

Since the dip coating is capable of coating both sides at one time, the manufacturing costs can be reduced, and moreover, there is an additional advantage that uniform coating layers can be formed on both sides by varying the concentration of the slurry and the speed of the coating.

In order to accomplish the foregoing and other objects, the present invention also provides a method of manufacturing a non-aqueous electrolyte battery, comprising the steps of: preparing a separator by coating a slurry containing filler particles, a water-insoluble binder, a water-soluble binder, and water onto at least one surface of a porous separator main body and drying the slurry to form a coating layer on the one surface of the separator main body; preparing an electrode assembly by interposing the separator between a positive electrode and a negative electrode so that the coating layer is disposed on a negative electrode side of the separator, the positive electrode having a positive electrode active material containing at least lithium and either cobalt or manganese, and the negative electrode having a negative electrode active material; and impregnating the electrode assembly with a non-aqueous electrolyte.

Such a manufacturing method makes it possible to manufacture a non-aqueous electrolyte battery that uses a water-insoluble binder and a water-soluble binder as the binder when forming the coating layer of the separator.

It is desirable that the slurry contain surfactant.

The reason is the same as that discussed above.

It is desirable that, in the step of preparing the separator, the coating layer be formed by doctor blading, gravure coating, transfer coating, or die coating.

The reason is that the dip coating inevitably forces both sides of the separator to be coated, but the doctor blading and so forth make it possible to coat only one side of the separator easily.

### ADVANTAGES OF THE INVENTION

According to the present invention, the coating layer provided on the surface of the separator main body exhibits a filtering function to an appropriate degree. Thus, the coating layer traps the decomposition products of the electrolyte solution resulting from the reaction at the positive electrode as well as the cobalt or manganese ions dissolved away from the positive electrode active material, hindering the cobalt or manganese from depositing on the negative electrode and the separator. As a result, damages to the negative electrode and the separator are alleviated, and therefore, advantageous effects are obtained that the deterioration in cycle performance under high temperature conditions and the deterioration in storage performance under high temperature conditions can be lessened.

Moreover, according to the present invention, a surface film originating from LiBF₄ is formed on the surface of the positive electrode active material because LiBF₄ is added to the electrolyte solution. Therefore, the amounts of the decomposition products of the electrolyte solution resulting from the reaction at the positive electrode and the cobalt or manganese ions dissolved away from the positive electrode active material reduce. Furthermore, the coating layer provided between the positive electrode and the separator exhibits a filtering function to an appropriate degree. Thus, the decomposition products of the electrolyte solution resulting from the reaction at the positive electrode and the cobalt or manganese ions dissolved away from the positive electrode active material are trapped by the coating layer, so the cobalt or manganese is hindered from depositing on the negative electrode and the separator sufficiently. As a result, damages to the negative electrode and the separator are alleviated dramatically, and therefore, an excellent advantageous effect is exhibited that the deterioration in the cycle performance under high temperature conditions and the deterioration in the storage performance under high temperature conditions can be lessened. What is more, there is an advantageous effect that the coating layer can be prevented from coming off from the positive electrode active material layer or the separator since the binder firmly bonds the inorganic particles to each other and the coating layer to the positive electrode active material layer or the separator.

### BEST MODE FOR CARRYING OUT THE INVENTION

Hereinbelow, the present invention is described in further detail based on preferred embodiments thereof. It should be construed, however, that the present invention is not limited to the following three embodiments, and various changes and modifications are possible without departing from the scope of the invention.

### FIRST EMBODIMENT

The first embodiment describes an embodiment in which a water-insoluble binder alone is used as the binder of the coating layer of the separator.

### [Preparation of Positive Electrode]

First, lithium cobalt oxide (in which 1.0 mol. % of Al and 1.0 mol. % of Mg are contained in the form of solid solution and 0.05 mol. % of Zr is present on the surface) as a positive electrode active material, acetylene black as a carbon conductive agent, and PVDF as a binder agent were mixed together at a mass ratio of 95:2.5:2.5. Thereafter, the mixture was agitated together with NMP as a solvent, using a Combimix mixer made by Tokushu Kika Kogyo Co. Ltd., to thus prepare a positive electrode mixture slurry. Next, the resultant positive electrode mixture slurry was applied onto both sides of a positive electrode current collector made of an aluminum foil, and the resultant material was then dried and pressure-rolled, whereby a positive electrode was prepared in which positive electrode active material layers were formed on both surfaces of the aluminum foil. The filling density of the positive electrode active material layer was controlled to be 3.60 g/cc.

### Preparation of Negative Electrode

A carbonaceous material (artificial graphite), CMC (carboxymethylcellulose sodium), and SBR (styrene-butadiene rubber) were mixed in an aqueous solution at a mass ratio of 98:1:1 to prepare a negative electrode slurry. Thereafter, the negative electrode slurry was applied onto both sides of a copper foil serving as a negative electrode current collector, and the resultant material was then dried and pressure-rolled. Thus, a negative electrode was prepared. The filling density of the negative electrode active material layer was controlled to be 1.60 g/cc.

### [Preparation of Non-Aqueous Electrolyte]

A lithium salt composed of LiPF₆ was dissolved at a concentration of 1.0 mole/L in a mixed solvent of 3:7 volume ratio of ethylene carbonate (EC) and diethyl carbonate (DEC) to prepare a non-aqueous electrolyte.

### Preparation of Separator

First, an acetone solvent was mixed with 10 mass %, based on the mass of acetone, of TiO₂ particles (rutile-type, particle size 0.38 μm, KR380 manufactured by Titan Kogyo Co., Ltd.) serving as filler particles, and 10 mass %, based on the mass of TiO₂, of copolymer (elastic polymer) containing an acrylonitrile structure (unit), and a mixing and dispersing process was carried out using a Filmics mixer made by Tokushu Kika Kogyo Co. Ltd. Thereby, a slurry in which TiO₂ was dispersed was prepared. Next, the above-described slurry was coated onto both sides of a separator main body comprising a microporous film (film thickness: 18 μm, average pore size 0.6 μm, porosity 45%) made of polyethylene (hereinafter also abbreviated as “PE”) by dip coating. The solvent of the slurry was then removed by drying, whereby a coating layer was formed both sides of the separator main body. The thickness of the coating layer on both sides was 2 μm in total, and the film thickness of the separator main body was 18 μm. Therefore, the total film thickness of the separator was 20 μm.

### [Construction of Battery]

Respective lead terminals were attached to the positive and negative electrodes, and the positive and negative electrodes were wound in a spiral form with a separator interposed therebetween. The wound electrodes were then pressed into a flat shape to obtain an electrode assembly, and the prepared electrode assembly was placed into a space made by an aluminum laminate film serving as a battery case. Then, the non-aqueous electrolyte was filled into the space, and thereafter the battery case was sealed by welding the aluminum laminate film together, to thus prepare a battery. In this battery design, the end-of-charge voltage was controlled to be 4.4 V by adjusting the amounts of the active materials in the positive and negative electrodes, and moreover, the negative/positive electrode capacity ratio (initial charge capacity of the negative electrode/initial charge capacity of the positive electrode) was controlled to be 1.08 at this potential. The above-described battery had a design capacity of 780 mAh.

### SECOND EMBODIMENT

The second embodiment describes an embodiment in which a water-insoluble binder and a water-soluble binder are used as the binder of the coating layer of the separator.

A battery was fabricated in the same manner as in described in the first embodiment above, except that the separator was prepared in the following manner and that the coating layer of the separator described below was disposed on the negative electrode side.

First, 10 mass % of TiO₂ particles (rutile-type, particle size 0.38 μm, KR380 manufactured by Titan Kogyo Co., Ltd.) serving as filler particles, 1 mass % of copolymer (water-insoluble polymer) containing an acrylonitrile structures (unit) serving as a binder agent, and 1 mass % of CMC (carboxymethylcellulose sodium, water-soluble polymer) serving as a thickening agent, 1 mass % of polyalkylene-based nonionic surfactant, and 87 mass % of water as a solvent were mixed together, and a mixing and dispersing process was carried out using a Filmics mixer made by Tokushu Kika Kogyo Co., Ltd. Thereby, a slurry in which TiO₂ was dispersed was prepared. Next, the above-described slurry was coated onto one side of a separator main body comprising a microporous film (film thickness: 18 μm, average pore size 0.6 μm, porosity 45%) made of polyethylene (hereinafter also abbreviated as “PE”) by doctor blading. The solvent of the slurry was then removed by drying, whereby a coating layer was formed one side of the separator main body. The thickness of the coating layers was 2 μm, and the film thickness of the separator main body was 18 μm. Therefore, the total film thickness of the separator was 20 μm.

### THIRD EMBODIMENT

The third embodiment describes an embodiment in which LiBF₄ is added to the non-aqueous electrolyte solution.

A battery was fabricated in the same manner as in described in the first embodiment above, except that a non-aqueous electrolyte solution prepared in the following manner was used as the non-aqueous electrolyte solution and that a separator prepared in the following manner was used as the separator.

### [Preparation of Non-aqueous Electrolyte]

LiPF₆ and LiBF₄ were dissolved at a proportion of 1.0 mole/liter (M) and at a proportion of 1 mass %, respectively, in a mixed solvent of 3:7 volume ratio of ethylene carbonate (EC) and diethyl carbonate (DEC) to prepare a non-aqueous electrolyte.

### [Type of Separator]

A microporous PE film (film thickness: 12 μm, average pore size 0.1 μm, porosity 38%) was used as the separator main body, and the above-described slurry in which TiO₂ was dispersed was coated only on the surface of the positive electrode side of the separator main body by gravure coating, followed by removal of solvent by drying, whereby a separator was prepared.

### EMBODIMENTS

### Preliminary Experiment 1-1

The types of water-insoluble binders (binder agents) and the methods of dispersion process used for preparing the coating layer of the separator were varied to study what kind of water-insoluble binder and what method of dispersion process should be used to obtain good dispersion capability of the slurry. The results are shown in Table 1. In the present experiment, an organic solvent (specifically, acetone) was used as the solvent when preparing the slurry.

### (Water-Insoluble Binders Used and Methods of Dispersion Process)

### [1] Water-Insoluble Binders Used

Three types of water-insoluble binders were used, namely, PVDF (KF1100 made by Kureha Corp., one commonly used for a positive electrode for lithium-ion battery, hereinafter also abbreviated as PVDF for positive electrode), PVDF for gel polymer electrolyte (PVDF-HFP-PTFEcopolymer, hereinafter also abbreviated as PVDF for gel polymer electrolyte), and elastic polymer containing an acrylonitrile unit.

### [2] Methods of Dispersion Process

A dispersion process with a disperser (30 minutes at 3000 rpm), a dispersion process using a Filmics mixer made by Tokushu Kika Kogyo Co., Ltd. (30 seconds at 40 m/min.) and a bead mill dispersion process (10 minutes at 1500 rpm) were used. For reference, unprocessed subjects were also tested.

### (Specific Details of the Experiment)

The above-described methods of dispersion process were used while varying types and concentrations of the water-insoluble binder, to determine precipitation conditions of the filler particles (titanium oxide [TiO₂] particles herein) after an elapse of one day.

TABLE 1

| Binder | | | | | |
|---|---|---|---|---|---|
| | Amount | Method of dispersion | | | |
| Type | (mass %) | Disperser | Filmics | Bead mill | Unprocessed |
| PVDF for | 1 | X | X | X | X |
| positive | 3 | X | OK | OK | X |
| electrode | 5 | X | OK | OK | X |
| | 10 | X | OK | OK | X |
| PVDF | 1 | X | X | X | X |
| for gel | 3 | X | OK | OK | X |
| electrolyte | 5 | X | OK | OK | X |
| | 10 | X | OK | OK | X |
| Elastic | 1 | X | OK | OK | X |
| polymer | 3 | X | OK | OK | X |
| containing | 5 | OK | OK | OK | X |
| acrylonitrile | 10 | OK | OK | OK | X |
| unit | | | | | |

Note:
“OK” means that no precipitation was observed, and
“X” means that precipitation was observed.

### (Results of the Experiment)

[1] Results of the Experiment concerning Types of Water-Insoluble Binders

As clearly seen from Table 1, it was observed that both the PVDFs (PVDF for positive electrode and PVDF for gel polymer electrolyte) tend to precipitate more easily than the elastic polymer containing an acrylonitrile unit, although both the PVDFs have such a tendency that they are less prone to precipitate as the amount of the PVDF added is greater. Therefore, it is preferable to use the elastic polymer containing an acrylonitrile unit as the water-insoluble binder. The reasons are as follows.

In order to obtain the advantageous effects of the present invention, it is preferable to form a coating layer as dense as possible. In that sense, it is preferable to use filler particles with sizes of sub-microns or smaller. However, filler particles tend to aggregate easily depending on the particle size, so it is necessary to prevent reaggregation after the particles are disentangled (dispersed).

On the other hand, the water-insoluble binder requires the following functions or properties in order to obtain the advantageous effects.

(I) The function to ensure the binding capability for withstanding the manufacturing process of the battery

(II) The function to fill the gaps between the filler particles by swelling after absorbing the electrolyte solution

(III) The function to ensure the dispersion capability of the filler particles (function of reaggregation prevention)

(IV) The characteristics of causing little dissolution into the electrolyte solution

Here, the inorganic particles made of such substances as titania and alumina, used as the filler particles, have a high affinity with the binders that have acrylonitrile-based molecular structures, and the binders having these types of groups (molecular structures) show higher dispersion capability. Accordingly, it is desirable to adopt a copolymer containing an acrylonitrile unit, which can exhibit the above-mentioned functions (I) and (II) even when added in a small amount, and which has the characteristics (IV) and at the same time satisfies the function (III). Furthermore, an elastic polymer is preferable to obtain flexibility after bonded to the separator main body (to ensure the strength such that it does not break easily). From the foregoing, it is most preferable that the binder be an elastic polymer containing an acrylonitrile unit.

(2) Results of the Experiment concerning Methods of Dispersion

As clearly seen from Table 1, it is observed that, when conducting disentanglement (dispersion) of particles on the order of submicrons, the dispersion process with a disperser causes precipitation in most of the cases, but the disentanglement (dispersion) methods such as the Filmics process and the bead mill process (the dispersion methods commonly used in the field of paint) do not cause precipitation in most of the cases. In particular, it is desirable to employ the dispersion process methods such as the Filmics process and the bead mill process, taking into consideration that it is extremely important to ensure the dispersion capability of the slurry in order to carry out uniform coating of the separator main body. Although not shown in Table 1, it has been confirmed that the dispersion by an ultrasonic method cannot achieve sufficient dispersion performance.

### Preliminary Experiment 1-2

What type of water-insoluble binder and what type of dispersion process should be used to obtain good dispersion capability of the slurry were investigated by varying the type of water-insoluble binder and the method of dispersion processes used for preparing the coating layer of the separator. The results are shown in Table 2. The present experiment is significantly different from the foregoing preliminary experiment 1-1 in that water is used as the solvent when preparing the slurry.

### (Water-Insoluble Binders Used and Methods of Dispersion Process)

### [1] Water-Insoluble Binders Used

Three types of water-insoluble binders (specifically water-insoluble polymers, having the function as a binder agent) were used, namely, PTFE (polytetrafluoroethylene), SBR (styrene-butadiene rubber), and copolymer containing an acrylonitrile structure (unit).

### [2] Methods of Dispersion Process

A disperser dispersion process (30 minutes at 3000 rpm), a dispersion process using a Filmics mixer made by Tokushu Kika Kogyo Co., Ltd. (30 seconds at 40 m/min.) and a bead mill dispersion process (10 minutes at 1500 rpm) were used. For reference, unprocessed subjects were also tested.

### (Specific Details of the Experiment)

The above-described methods of dispersion process were used while varying types and concentrations of the water-insoluble binder, to determine precipitation conditions of the filler particles (titanium oxide [TiO₂] particles herein) after an elapse of one day. In addition, CMC (carboxymethylcellulose sodium, in an amount of 1 mass % with respect to the total amount of the slurry) as a water-soluble binder (thickening agent) and a polyalkylene-based nonionic surfactant (in an amount of 1 mass % with respect to the total amount of the slurry) as a surfactant were used when performing the above-mentioned dispersion processes.

TABLE 2

| Binder | | | | | |
|---|---|---|---|---|---|
| | Amount | Method of dispersion | | | |
| Type | (mass %) | Disper | Filmics | Bead mill | Unprocessed |
| PTFE | 1 | X | OK | OK | X |
| | 3 | OK | OK | OK | X |
| | 5 | OK | OK | OK | X |
| | 10 | OK | OK | OK | X |
| SBR | 1 | X | OK | OK | X |
| | 3 | OK | OK | OK | X |
| | 5 | OK | OK | OK | X |
| | 10 | OK | OK | OK | X |
| Copolymer | 1 | OK | OK | OK | X |
| containing | 3 | OK | OK | OK | X |
| acrylonitrile | 5 | OK | OK | OK | X |
| unit | 10 | OK | OK | OK | X |

Note:
“OK” means that no precipitation was observed, and
“X” means that precipitation was observed.

### (Results of the Experiment)

[1] Results of the Experiment concerning Types of Water-Insoluble Binders

As clearly seen from Table 2, it is observed that the dispersion capability was relatively ensured irrespective of the types of water-insoluble binders, unlike the foregoing preliminary experiment 1-1. The reason is believed to be attributable to the use of the water-soluble binders (thickening agents) in the present experiment as described above.

It is observed that particularly good dispersion capability is obtained when the copolymer containing an acrylonitrile structure. It is believed that because there exist a hydrophilic portion and a lipophilic portion appropriately in the polymer molecular because of the structure of acrylonitrile, the effect of preventing reaggregation of the filler particles is exerted. Therefore, the copolymer containing an acrylonitrile structure satisfies the function (III) shown in the above preliminary experiment 1-1 and also at the same time has the functions (I) and (II) as well as the characteristics (IV) shown in the preliminary experiment 1-1. In addition, it was observed whether precipitation was caused or not when the slurry was set aside for a greater number of days. As a result, it was confirmed that the copolymer containing an acrylonitrile structure caused less than precipitation than SBR and PTFE.

Moreover, SBR and the copolymer containing an acrylonitrile structure are superior in flexibility after being dried than PTFE although it is not directly related to dispersion capability. In particular, the flexibility and strength of the coating layer after being coated are important in the sense that good handleability on the separator, which is a thin film requiring a high degree of freedom, should be ensured. In that sense, flexibility such as elasticity is essential, so SBR and the copolymer containing an acrylonitrile structure are desirable from such a viewpoint. Nevertheless, it has been well known that SBR decomposes at the positive electrode potential. Therefore, it is undesirable to use an electrochemically instable material as the water-insoluble binder, although the coating layer is not disposed on the surface that comes in contact with the positive electrode (i.e., the coating layer is disposed on the surface of the negative electrode side of the separator). For these reasons, the copolymer containing an acrylonitrile structure is most desirable as the water-insoluble binder.

(2) Results of the Experiment concerning Methods of Dispersion

As clearly seen from Table 1, it is observed that the dispersion process with a disperser causes precipitation in a few cases, but the disentanglement (dispersion) methods such as the Filmics process and the bead mill process (the dispersion methods commonly used in the field of paint) do not cause precipitation at all. In particular, because the particle size of the inorganic particles used is small in the present invention, sedimentation in the slurry is significant and a uniform film cannot be formed unless the dispersion process is performed mechanically to some degree. For this reason, it is preferable to use a dispersion method that can disentangle particles of ceramic or the like by applying a mechanical stress, such as a Filmics method and a bead mill method. It is believed that the dispersion method with a disperser showed the results as described above because its capability of disentangling particles of ceramic or the like with small particle sizes.

### Preliminary Experiment 2

What kind of coating method is desirable for forming the coating layer was investigated by coating the slurry onto the separator main body with various methods of coating. The present experiment examined a case in which water was used and a case in which an organic solvent was used as the solvent when preparing the slurry.

### (Coating Methods Used)

A slurry was coated on both sides of a separator main body using dip coating, gravure coating, die coating, doctor blading, and transfer coating.

### (Results of the Experiment)

(a) The cases where an organic solvent is used as the solvent (the cases where the binder contains a water-insoluble binder alone)

In the methods other than dip coating, the slurry needs to be coated onto only one side at a time of the separator main body made of a microporous film, so when coating one side, the water-insoluble binder infiltrates to the other side. This causes problems that the concentration of the water-insoluble binder is changed (diluted) in the coating layer and that the concentration of the water-insoluble binder increases in the separator main body when both sides are coated, resulting in a deterioration of air permeability. In order to avoid these problems, it is desirable to adopt dip coating.

This technique can hinder the just-mentioned problems and moreover can is capable of coating both sides at one time. Therefore, the coating process can be simplified, and moreover, there is an additional advantage that uniform coating layers can be formed on both sides by varying the concentration of the slurry and the speed of coating. When uniform coating layers have not been formed, compressing the separator may appear conceivable. However, compressing the separator is undesirable because it may pose a considerable risk of forming pinholes or the like.

In addition, in order to ensure sufficient battery performance, it is preferable that the filling density of the filler particles be assured to an appropriate degree. In that sense as well, the use of dip coating is preferable because it can control the coating density to be low.

When dip coating is adopted, it is preferable that the concentration of the solid content (the concentration of the filler particles and the water-insoluble binder) in the slurry be low to perform smoothly coating. However, even when the concentration of the solid content in the slurry is high to a certain degree, the coating thickness can be controlled by scraping or the like. For this reason, it is possible that the concentration of the solid content in the slurry may be up to about 60 mass % at the maximum.

Here, the separator main body is commonly made of PE (polyethylene) or PP (polypropylene), so it is generally desirable that the drying temperature for the slurry be 60° C. or lower, taking into consideration that it can cause shrinkage because of the temperature applied during the drying, although it may depend on the facilities used and the conditions of the slurry. Also, it is effective to dry the separator main body while a certain degree of tension is applied thereto, taking into consideration that the separator main body tends to shrink easily if no load is applied thereto at the time of heating. Furthermore, in view of these circumstances, the solvent for dispersing the filler particles should preferably have high volatility, and it is preferable that the solvent have a higher volatility and a lower boiling point than NMP, which is used commonly for batteries. Examples of such a solvent include acetone and cyclohexane.

Examples of the method of drying other than heating include evaporation by dry air and drying by controlling air flow.

(a) The cases where water is used as the solvent (the cases where the binder contains a water-insoluble binder and a water-soluble binder)

As described above, the coating layer using water as the solvent achieves good battery performance when is disposed on the negative electrode side of the separator, but when this coating layer is disposed on the positive electrode side, the battery performance is lowered considerably. For this reason, the use of dip coating, which necessitates both-side coating of the separator, is undesirable and it is desirable to use doctor blading, die coating, gravure coating, or transfer coating, any of which can perform one-side coating of the separator easily, for preparing the coating layer using water as the solvent.

When one of these coating methods is adopted, the concentration of the solid content (the concentration of the filler particles and the water-insoluble binder) in the slurry should preferably be low for the reason that formation of a thin film is necessary. However, even when the concentration of the solid content in the slurry is high to a certain degree, the coating thickness can be controlled by scraping or the like. For this reason, it is possible that the concentration of the solid content in the slurry may be up to about 60 mass % at the maximum.

When uniform coating layers have not been formed by one of the above-mentioned coating methods, compressing the separator may appear conceivable. However, compressing the separator is undesirable because it may pose a considerable risk of forming pinholes or the like.

### Preliminary Experiment 3

The pore size of the separator main body was varied to find out what particle size of the filler particles (titanium oxide [TiO2] particles herein) is desirable in the slurry when forming the coating layer. The results are shown in Table 3. For reference, Table 3 also shows the results for the one in which no coating layer was formed. In the present experiment, an organic solvent was used as the solvent when preparing the slurry.

### (Separator Main Bodies Used)

Separator main bodies with average pore sizes of 0.1 μm, 0.3 μm, and 0.6 μm were used.

### (Specific Details of the Experiment)

The slurry was coated on both sides of the separator main body by dip coating, and thereafter, a cross section of the separator was observed using SEM. The average particle size of the titanium oxide particles in the slurry was 0.38 μm.

In addition, a withstanding voltage test was also conducted as follows. Laminate type batteries were fabricated using the separators obtained by coating the slurry onto the respective separator main bodies (the non-aqueous electrolyte solution was not supplied), and a voltage of 200 V was applied to the batteries to confirm whether or not short circuits occurred in the batteries.

### (Results of the Experiment)

TABLE 3

| | | Seprator average pore size | | |
|---|---|---|---|---|
| | | 0.1 μm | 0.3 μm | 0.6 μm |
| Coating layer | Yes | 0/10 | 0/10 | 3/10 |
| | No | 0/10 | 0/10 | 0/10 |

A cross-section of each of the separators was observed by SEM. As a result, it was confirmed that, in the ones in which the average particle size of the filler particles is greater than the average pore size of the separator main body (the ones in which the separator main body has an average pore size of 0.1 μm or 0.3 μm), generally the micropores in the separator main body were not plugged and almost no entry of the filler particles in the separator main body was observed. In contrast, it was observed that, in the one in which the average particle size of the filler particles is less than the average pore size of the separator main body (the one in which the separator main body has an average pore size of 0.6 μm), a substantial amount of the filler particles entered from the surface into the interior of the separator main body.

In addition, as clearly seen from Table 3, the results of the withstanding voltage test revealed that the samples in which the average particle size of the filler particles was less than the average pore size of the separator main body tend to show a higher defect rate than that in which no coating layer was formed, whereas the samples in which the average particle size of the filler particles was greater than the average pore size of the separator showed the same level of defective rate as those in which no coating layer was formed. The reason is believed to be as follows. In the former case, the separator main body is partially pierced during the winding and pressing or due to the effect of the winding tension, and a portion with a low resistance is formed partially. In the latter case, almost no filler particles enter the interior of the separator main body since a uniform coating layer is formed on the surface of the separator main body, so the separator main body is prevented from being pierced.

From the foregoing, it will be understood that it is desirable that the average particle size of the filler particles be greater than the average pore size of the separator main body.

The values of average particle size of the filler particles were measured by a particle size distribution method.

It is believed that, although an organic solvent was used as the solvent when preparing the slurry in the present experiment, the same effects will be obtained when water is sued as the solvent when preparing the slurry.

### Preliminary Experiment 4

An air permeability measurement was conducted to find out that to what degree the air permeability of the separator is affected by the presence or absence of the coating layer, the thickness of the coating layer, and so forth. In the present experiment, an organic solvent was used as the solvent when preparing the slurry.

### (Separators Used)

The separators used in this experiment were: the separators (separators CS1 to CS6, in which the average pore size, the film thickness, and the porosity were varied) each made of microporous PE film alone, and the separators (separators IS1 to IS6, in which the film thickness of the coating layer was varied) in each of which a coating layer was formed on a surface of a separator main body (one selected from the above separators CS1, CS2, and CS5) made of a microporous PE film.

### (Specific Details of the Experiment)

### [1] Measurement of Separator Porosity

Prior to the later-described air permeability measurement for the separators, the porosity of each of the separators (the separator main bodies in the case of separators IS1 to IS6) was measured in the following manner.

First, a sample of the film (separator or separator main body) was cut into a 10 cm×10 cm square, and the mass (W g) and the thickness (D cm) of the sample were measured. The mass of each of the materials within the sample was determined by calculation, and the mass of each of the materials [Wi (i=1 to n)] was divided by the absolute specific gravity, to assume the volume of each of the materials. Then, porosity (volume %) was determined using the following equation 1.

Porosity (%)=100−{(W1/Absolute specific gravity 1)+(W2/Absolute specific gravity 2)+ . . . +(Wn/Absolute specific gravity n)}×100/(100D). (1)

The separator (separator main body) of the present invention, however, is made of PE alone, and therefore, the porosity thereof can be determined using the following equation (2).

Porosity (%)=100−{(Mass of PE/Absolute specific gravity of PE)}×100/(100D). (2)

[2] Measurement of Air Permeability of Separators

This measurement was carried out according to JIS P8117, and the measurement equipment used was a B-type Gurley densometer (made by Toyo Seiki Seisaku-sho, Ltd.).

Specifically, a sample was fastened to a circular hole (diameter: 28.6 mm, area: 645 mm²) of the inner cylinder (mass: 567 g), and the air (100 cc) in the outer cylinder was passed through the circular hole of the test cylinder to the outside of the cylinder. The time it took for the air (100 cc) in the outer cylinder to pass through the separator was measured, and the value obtained was employed as the air permeability of the sample.

### (Results of the Experiment)

TABLE 4

| | Total film thickness | | | | | | | |
|---|---|---|---|---|---|---|---|---|
| | [Thickness of | Separator main body | | | | | | |
| | separator main body + | (Separator in CS1-CS6) | | | Coating layer | | | |
| Separator | thickness of coating | Average | Film | | | Film thickness | Air permeability | |
| (Separator | layer] | pore size | thickness | Porosity | | [both sides] | [air] | |
| main body) | (μm) | (μm) | (μm) | (%) | Formation | (μm) | (s/100 cc) | Batteries applied |
| Separator | 20 | 0.6 | 18 | 45 | Yes | 2 | 130 | A1, B1, |
| IS1(CS1) | | | | | | | | B3, B5 |
| Separator | 19 | 0.6 | 18 | 45 | Yes | 1 | 115 | C1 |
| IS2(CS1) | | | | | | | | |
| Separator | 22 | 0.6 | 18 | 45 | Yes | 4 | 150 | C2 |
| IS3(CS1) | | | | | | | | |
| Separator | 14 | 0.1 | 12 | 38 | Yes | 2 | 305 | A2, B2, |
| IS4(CS2) | | | | | | | | B4, B6, D1, D2 |
| Separator | 25 | 0.6 | 23 | 48 | Yes | 2 | 110 | A3 |
| IS5(CS5) | | | | | | | | |
| Separator | 18 | 0.6 | 18 | 45 | No | — | 110 | Comp. Z1, Y1, Y3, Y5 |
| CS1 | | | | | | | | |
| Separator | 12 | 0.1 | 12 | 38 | No | — | 290 | Comp. Z2, Y2, Y4, Y6, |
| CS2 | | | | | | | | X1-X3 |
| Separator | 16 | 0.1 | 16 | 47 | No | — | 190 | Comp. Z3 |
| CS3 | | | | | | | | |
| Separator | 20 | 0.05 | 20 | 38 | No | — | 500 | Comp. Z4 |
| CS4 | | | | | | | | |
| Separator | 23 | 0.6 | 23 | 48 | No | — | 85 | Comp. Z5 |
| CS5 | | | | | | | | |
| Separator | 27 | 0.6 | 27 | 52 | No | — | 90 | Comp. Z6 |
| CS6 | | | | | | | | |

In Separators CS1 to CS6, the thickness of separator main body and the total film thickness are identical because they do not have a coating layer, i.e., they are composed only of a separator main body.
The type of separator (selected from separators CS1, CS2, and CS5) used as the separator main body is shown in the parentheses after IS1 to IS5.

As clearly seen from Table 4, the separators having the coating layer showed lower air permeability than the separators without the coating layer, when the separators having the same average pore size, film thickness, and porosity are compared to each other (compare the separator CS1 and the separators IS1 to IS3, the separator CS2 and the separator IS4, and the separator CS5 and the separator IS5). In addition, among the separators having the coating layer, the air permeability is poorer (compare the separators IS1 to IS3) when the thickness of the coating layer is greater.

It is also understood that the air permeability tends to be poorer when the average pore size of the separator is smaller (for example, see the separators CS2 and CS4) among the separators that do not have the coating layer. It should be noted, however, that a separator with a large porosity can prevent the air permeability from degrading even when the separator has a small average pore size (compare the separator CS2 and the separator CS3). Moreover, it will also be understood that when the film thickness of the separator is greater, the air permeability decreases (compare the separator CS5 and the separator CS6).

The air permeability measurement after the coating layer has been formed was not performed for a separator having the coating layer employing water as the solvent (i.e., a separator used in the second embodiment that has a coating layer employing a water-insoluble binder and a water-soluble binder as the binder) and a separator used for a battery in which the electrolyte solution contains LiBF₄ (a separator used in he third embodiment). For understanding what types of separators were used for the batteries in the later-described Examples, correspondence between the separators and the batteries is shown in Tables 5 and 6. The air permeability values shown in Tables 5 and 6 are air permeability values for the separator main bodies alone (on which no coating layer is formed).

TABLE 5

| | Separator | | | | | |
|---|---|---|---|---|---|---|
| | | | | | Coating layer | |
| | Total film thickness | | | | | Concentration |
| Type of | [Thickness of separator | | | | | of titanium oxide |
| separator | main body + | Separator main body | | | | with respect to total |
| (Separator | thickness of coating layer] | | Film thickness | | Presence | amount of slurry |
| main body) | (μm) | Average pore size (μm) | (μm) | Porosity (%) | (Location) | (mass %) |
| Separator | 20 | 0.6 | 18 | 45 | Yes | 10 |
| IS11(CS1) | | | | | (Negative | |
| Separator | | | | | electrode | |
| IS12(CS1) | | | | | side) | |
| Separator | | | | | | |
| IS13(CS1) | | | | | | |
| Separator | 21 | | | | | |
| IS14(CS1) | | | | | | |
| Separator | 14 | 0.1 | 12 | 38 | | |
| IS15(CS2) | | | | | | |
| Separator | 25 | 0.6 | 23 | 48 | | |
| IS16(CS5) | | | | | | |
| Separator | 20 | 0.6 | 18 | 45 | Yes | |
| CS11(CS1) | | | | | (Positive | |
| Separator | 14 | 0.1 | 12 | 38 | electrode | |
| CS12(CS2) | | | | | side) | |

| | Separator | | | | | |
|---|---|---|---|---|---|---|
| | Coating layer | | | | | |
| | Concentration of | Concentration of | Concentration of | | | |
| Type of | copolymer with respect | CMC with respect | surfactant with respect | | Air permeability | |
| separator | to total amount of | to total amount of | to total amount of | | of separator main | |
| (Separator | slurry | slurry | slurry | Thickness | body [air] | |
| main body) | (mass %) | (mass %) | (mass %) | (μm) | (s/100 cc) | Batteries applied |
| Separator | 1 | 1 | 1 | 2 | 110 | E1, |
| IS11(CS1) | | | | | | F1, F3 |
| Separator | 0.5 | | | | | G1 |
| IS12(CS1) | | | | | | |
| Separator | 2 | | | | | G2 |
| IS13(CS1) | | | | | | |
| Separator | 5 | | | 3 | | G3 |
| IS14(CS1) | | | | | | |
| Separator | 1 | | | 2 | 290 | E2, |
| IS15(CS2) | | | | | | H1, H2, |
| | | | | | | F2, F4, F5 |
| Separator | 1 | | | | 85 | E3 |
| IS16(CS5) | | | | | | |
| Separator | 1 | | | | 110 | Com. W1 |
| CS11(CS1) | | | | | | |
| Separator | 10 | | | | 290 | Comp. W2, |
| CS12(CS2) | | | | | | V1, V2, V3 |

The type of separator (selected from separators CS1, CS2, and CS5) used as the separator main body is shown in the parentheses for Separators IS11 to IS16 and Separators CS11 and CS12.
“Copolymer” means a copolymer containing an acrylonitrile structure (unit).

TABLE 6

| | Total film thickness | | | | | | | |
|---|---|---|---|---|---|---|---|---|
| | [Thickness of | Separator main body | | | Coating layer | | | |
| | separator main body + | (Separator in CS1-CS6) | | | | Film | | |
| Separator | thickness of coating | Average | Film | | | thickness | Air permeability | |
| (Separator | layer] | pore size | thickness | Porosity | Formation | [both sides] | [air] | |
| main body) | (μm) | (μm) | (μm) | (%) | (Location) | (μm) | (s/100 cc) | Batteries applied |
| Separator | 14 | 0.1 | 12 | 38 | Yes | 2 | 290 | J |
| IS17 (CS2) | | | | | (Positive | | | Comp. V1 |
| | | | | | electrode | | | |
| | | | | | side) | | | |
| Separator | 12 | 0.1 | 12 | 38 | No | — | 290 | Comp. V2, V3 |
| CS2 | | | | | | | | |
| Separator | 18 | 0.1 | 16 | 47 | Yes | 2 | 190 | K |
| IS18 (CS3) | | | | | (Negative | | | |
| | | | | | electrode | | | |
| | | | | | side) | | | |
| Separator | 16 | 0.1 | 16 | 47 | No | — | 190 | Comp. V1, V2 |
| CS3 | | | | | | | | |

In Separators CS2 and CS3, the thickness of separator main body and the total film thickness are identical because they do not have a coating layer, i.e., they are composed only of a separator main body.
The type of separator (selected from separators CS2 and CS3) used as the separator main body is shown in the parentheses after Separators IS17 and IS18.

### Preliminary Experiment 5

As has been discussed in the Background of the Invention, although the use of lithium cobalt oxide as the positive electrode active material is preferable in order to achieve a battery with a higher capacity, problems also exist. In order to resolve or alleviate the problems, various elements were added to lithium cobalt oxide to find what kind of element is suitable.

### (Preconditions in Selecting Additive Element)

Prior to selecting additive elements, the crystal structure of lithium cobalt oxide was analyzed. The result is shown in FIG. 1 [reference: T. Ozuku et. al, J. Electrochem. Soc. Vol. 141, 2972 (1994)].

As will be clearly seen from reviewing FIG. 1, it has been found that the crystal structure (particularly the crystal structure along the c-axis) is greatly disintegrated when the positive electrode is charged to about 4.5 V or higher versus a lithium reference electrode potential (i.e., charged to a battery voltage of 4.4 V or higher, since the battery voltage is about 0.1 V lower than the potential of the lithium reference electrode). Thus, it has been observed that the crystal structure of lithium cobalt oxide becomes more unstable as the charge depth increases. Moreover, it has also been found that the deterioration of the lithium cobalt oxide accelerates when exposed in a high temperature atmosphere.

### (Details of Selection of Additive Elements)

As a result of assiduous studies, we have found that, in order to alleviate the disintegration of the crystal structure, it is very effective to cause Mg or Al to dissolve in the interior of the crystal to form a solid solution. In this respect, both Mg and Al are effective to the same degree, but Mg has less adverse effects on the later-described other battery characteristics. For this reason, it is more preferable that Mg is dissolved in the form of solid solution.

Although these elements contribute to the stabilization of the crystal structure, they may bring about degradation in the initial charge-discharge efficiency and a decrease in the discharge working voltage. For the purpose of alleviating these problems, the present inventors conducted experiments assiduously and as a result found that the discharge working voltage is significantly improved by adding a tetravalent or pentavalent element, such as Zr, Sn, Ti, or Nb, to lithium cobalt oxide. An analysis was conducted for lithium cobalt oxides to which a tetravalent or pentavalent element was added, and it was found that such an element existed on the surfaces of the lithium cobalt oxide particles, and basically, they did not form a solid solution with lithium cobalt oxide, but was kept in the state of being electrically in direct contact with the lithium cobalt oxide. Although the details are not yet clear, it is believed that these elements serve to significantly reduce the interface charge transfer resistance, i.e., the resistance in the interface between the lithium cobalt oxide and the electrolyte solution, and that this contributes to the improvement in the discharge working voltage.

However, in order to ensure the state in which the lithium cobalt oxide and the additive element are directly electrically in contact with each other, it is necessary to sinter the material after the additive element material is added. In this case, among the above-mentioned elements, Sn, Ti, and Nb usually serve to inhibit crystal growth of the lithium cobalt oxide and therefore tend to lower the safety of the lithium cobalt oxide itself (when the crystallite size is small, the safety tends to be poor). On the other hand, Zr was found to be advantageous in that it does not impede crystal growth of the lithium cobalt oxide and moreover it improves the discharge working voltage.

Thus, it was found preferable that when using lithium cobalt oxide at 4.3 V or higher, particularly at 4.4 V or higher versus the potential of a lithium reference electrode, Al or Mg should be dissolved in the interior of the crystal of the lithium cobalt oxide in order to stabilize the crystal structure of the lithium cobalt oxide, and at the same time, Zr should be directly electrically in contact with the surface of the lithium cobalt oxide particles in order to compensate the performance degradation resulting from dissolving Al or Mg in the lithium cobalt oxide to form a solid solution.

It should be noted that the proportions of Al, Mg, and Zr to be added are not particularly limited.

### Preconditions for the Later-described Experiments (Operating Environment)

As previously discussed in the Background of the Invention, mobile devices have required higher capacity and higher power batteries in recent years. In particular, mobile telephones tend to increase in power consumption because more advanced functions are required, such as full color images, moving pictures, and gaming. Currently, with a greater number of functions provided for such advanced mobile telephones, it has been desired that batteries used as the power source for the mobile telephones should have a higher capacity. Nevertheless, the improvements in battery performance have not reached that far, so the users are often compelled to use the mobile phones for watching TV programs or playing video games while charging the batteries simultaneously. Under such circumstances, the batteries are used constantly in a fully charged state, and also a high power is consumed. Consequently, the use environment often results in a temperature of 50° C. to 60° C.

In this way, the use environment for the mobile telephones have changed greatly along with the technological advancements of the mobile telephones, from the environment with only voice calls and electronic mails to the one with moving pictures and video games, and accordingly, the batteries have been demanded to guarantee a wide operating temperature range from room temperature to about 50-60° C. Also, increasing the capacity and raising the output power particularly accompany a large amount of heat generated in the interior of the battery, and the operating environment of the battery also tends to be in a high temperature range, so it is necessary to ensure the battery reliability under high temperature conditions.

In view of these circumstances, we have devoted a great deal of effort to improvements in the battery performance as determined by the cycle test under environments at 40° C. to 60° C. and the storage test under a 60° C. atmosphere. More specifically, conventional storage tests have had the implications of an accelerated test for the storage at room temperature; however, as the capabilities of the materials have been utilized to their limits as a result of the advancements in battery performance, the implications of the accelerated test for the storage at room temperature have gradually faded, and the emphasis of the tests has shifted to a durability test close to the real use level. In view of these situations, we have decided to study the differences between the present invention and the conventional technology in storage tests in a charged state (a storage test at 80° C. for 4 days for the batteries designed to have an end-of-charge voltage of 4.2 V, and a storage test at 60° C. for 5 days for the batteries designed to have a higher end-of-charge voltage, since the higher the end-of-charge voltage of the fabricated battery is, the more severe the conditions of the deterioration).

In the following description, examples of the present invention are categorized into 10 groups so that the advantageous effects of the invention can be readily understood. The First to Fourth groups of Examples describe the cases in which a water-insoluble binder alone is used as the binder (i.e., the cases in which an organic solvent is used as the solvent, corresponding to the first embodiment described in the Best Mode for Carrying out the Invention above), the Fifth to Eighth groups of Examples describe the cases in which a water-insoluble binder and a water-soluble binder are used as the binder (i.e., the cases in which water is used as the solvent, corresponding to the second embodiment described in the Best Mode for Carrying out the Invention above), and the Ninth and Tenth Groups of Examples describe the cases in which LiBF₄ is added to the non-aqueous electrolyte solution (i.e., the cases corresponding to the third embodiment described in the Best Mode for Carrying out the Invention above).

### A. EXAMPLES RELATED TO THE FIRST EMBODIMENT

### First Group of Examples

The relationship between the physical properties of separator and the storage performance in a charged state was investigated by using various separators (or separator main bodies in the cases of the batteries of the invention), while the end-of-charge voltage and the filling density of the positive electrode active material layer were fixed at 4.40 V and 3.60 g/cc, respectively. The results are set forth below.

### Example 1

A battery prepared in the manner described in the first embodiment was used for Example 1.

The battery fabricated in this manner is hereinafter referred to as Battery Al of the invention.

### Example 2

A battery was fabricated in the same manner as described in Example 1 above, except that a separator main body having an average pore size of 0.1 μm, a film thickness of 12 μm, and a porosity of 38% was used as the separator main body. The total film thickness of the separator was 14 μm since the thickness of the coating layer on both sides was 2 μm in total.

The battery fabricated in this manner is hereinafter referred to as Battery A2 of the invention.

### Example 3

A battery was fabricated in the same manner as described in Example 1 above, except that a separator main body having an average pore size of 0.6 μm, a film thickness of 23 μm, and a porosity of 48% was used as the separator main body. The total film thickness of the separator was 25 μm since the thickness of the coating layer on both sides was 2 μm in total.

The battery fabricated in this manner is hereinafter referred to as Battery A3 of the invention.

### Comparative Example 1

A battery was fabricated in the same manner as described in Example 1 above, except that no coating layer was provided on the separator.

The battery fabricated in this manner is hereinafter referred to as Comparative Battery Z1.

### Comparative Example 2

A battery was fabricated in the same manner as described in Comparative Example 1 above, except that a separator having an average pore size of 0.1 μm, a film thickness of 12 μm, and a porosity of 38% was used as the separator. The battery fabricated in this manner is hereinafter referred to as Comparative Battery Z2.

### Comparative Example 3

A battery was fabricated in the same manner as described in Comparative Example 1 above, except that a separator having an average pore size of 0.1 μm, a film thickness of 16 μm, and a porosity of 47% was used as the separator. The battery fabricated in this manner is hereinafter referred to as Comparative Battery Z3.

### Comparative Example 4

A battery was fabricated in the same manner as described in Comparative Example 1 above, except that a separator having an average pore size of 0.05 μm, a film thickness of 20 μm, and a porosity of 38% was used as the separator.

The battery fabricated in this manner is hereinafter referred to as Comparative Battery Z4.

### Comparative Example 5

A battery was fabricated in the same manner as described in Comparative Example 1 above, except that a separator having an average pore size of 0.6 μm, a film thickness of 23 μm, and a porosity of 48% was used as the separator.

The battery fabricated in this manner is hereinafter referred to as Comparative Battery Z5.

### Comparative Example 6

A battery was fabricated in the same manner as described in Comparative Example 1 above, except that a separator having an average pore size of 0.6 μm, a film thickness of 27 μm, and a porosity of 52% was used as the separator. The battery fabricated in this manner is hereinafter referred to as Comparative Battery Z6.

### (Experiment)

The storage performance in a charged state (the remaining capacity after storage in a charged state) was determined for each of Batteries A1 to A3 of the invention and Comparative Batteries Z1 to Z6. The results are shown in Table 7 below. Based on the results obtained, a study was conducted about correlation between the physical properties of the separator (separator main body) and the remaining capacity after storage in a charged state. The results are shown in FIG. 2. The charge-discharge conditions and storage conditions were as follows.

### [Charge-Discharge Conditions]

Charge Conditions

Each of the batteries was charged at a constant current of 1.0 It (750 mA) until the battery voltage reached a predetermined voltage (i.e., the designed voltage of the battery, 4.40 V for all the batteries in the present experiment), and thereafter charged at the predetermined voltage until the current value reached 1/20 It (37.5 mA).

Discharge Conditions

Each of the batteries was discharged at a constant current of 1.0 It (750 mA) until the battery voltage reached 2.75 V.

The interval between the charge and the discharge was 10 minutes.

### [Storage Conditions]

Each of the batteries was charged and discharged one time according to the above-described charge-discharge conditions, and was again charged according to the charge conditions specified above to the predetermined voltage. Then, each of the charged batteries was set aside at 60° C. for 5 days.

### [Determination of Remaining Capacity]

Each of the batteries was cooled to room temperature and discharged under the same conditions as the above-described discharge conditions, to measure the remaining capacity. Using the discharge capacity obtained at the first time discharge after the storage test and the discharge capacity obtained before the storage test, the remaining capacity was calculated using the following equation (3).

Remaining capacity (%)=Discharge capacity obtained at the first-time discharge after storage test/Discharge capacity obtained before storage test×100. (3)

TABLE 7

| | Separator | | | | | | |
|---|---|---|---|---|---|---|---|
| | | Separator main body | | | | Coating layer | |
| | Total film | | | | Pore volume | | Concentration of titanium |
| Battery | thickness | Average pore size | Film thickness | Porosity | [Film thickness × Porosity] | | with respect to acetone |
| (Separator) | (μm) | (μm) | (μm) | (%) | (μm %) | Formation | (mass %) |
| A1 (IS1) | 20 | 0.6 | 18 | 45 | 810 | Yes | 10 |
| A2 (IS4) | 14 | 0.1 | 12 | 38 | 456 | | |
| A3 (IS5) | 25 | 0.6 | 23 | 48 | 1104 | | |
| Comp. Z1 | 18 | 0.6 | 18 | 45 | 810 | No | — |
| (CS1) | | | | | | | |
| Comp. Z2 | 12 | 0.1 | 12 | 38 | 456 | | |
| (CS2) | | | | | | | |
| Comp. Z3 | 16 | 0.1 | 16 | 47 | 752 | | |
| (CS3) | | | | | | | |
| Comp. Z4 | 20 | 0.05 | 20 | 38 | 760 | | |
| (CS4) | | | | | | | |
| Comp. Z5 | 23 | 0.6 | 23 | 48 | 1104 | | |
| (CS5) | | | | | | | |
| Comp. Z6 | 27 | 0.6 | 27 | 52 | 1404 | | |
| (CS6) | | | | | | | |

| | Separator | | | | |
|---|---|---|---|---|---|
| | Coating layer | | End-of-charge voltage (Positive | | |
| | Concentration of binder with | Thickness | electrode potential versus lithium | Filling density of positive | Remaining |
| Battery | respect to titanium oxide | [both sides] | reference electrode potential) | electrode active material layer | capacity |
| (Separator) | (mass %) | (μm) | (V) | (g/cc) | (%) |
| A1 (IS1) | 10 | 2 | 4.40 | 3.60 | 68.9 |
| A2 (IS4) | | | (4.50) | | 69.6 |
| A3 (IS5) | | | | | 70.2 |
| Comp. Z1 | — | — | | | 45.5 |
| (CS1) | | | | | |
| Comp. Z2 | | | | | 0.1 |
| (CS2) | | | | | |
| Comp. Z3 | | | | | 12.2 |
| (CS3) | | | | | |
| Comp. Z4 | | | | | 30.2 |
| (CS4) | | | | | |
| Comp. Z5 | | | | | 47.3 |
| (CS5) | | | | | |
| Comp. Z6 | | | | | 50.2 |
| (CS6) | | | | | |

In each of Comparative Batteries Z1 to Z6, the separators are composed only of the separator main body since no coating layer is provided.

### [Analysis]

### (1) Analysis on the Advantage of the Provision of the Coating Layer

As clearly seen from the results shown in Table 7, although in all the batteries the design voltage is 4.40 V and the positive electrode active material layer has a filling density of 3.60 g/cc, Batteries A1 to A3 of the invention, in which the coating layer is formed, prove to show significant improvements in remaining capacity over Comparative Batteries Z1 to Z6. The reason why such results were obtained will be detailed below.

There are possible causes of the deterioration in storage performance in a charged state, but taking into consideration that the positive electrode active material is used up to about 4.5 V versus the lithium reference electrode (the battery voltage is 0.1 V lower than that, i.e., about 4.4 V), the primary causes are believed to be as follows.

(I) The decomposition of the electrolyte solution in a strong oxidizing atmosphere due to the higher charge potential of the positive electrode.

(II) The deterioration due to the structure of the charged positive electrode active material that becomes unstable.

Not only do these factors bring about the deteriorations of the positive electrode and the electrolyte solution but also affect the clogging of the separator and the deterioration of the negative electrode active material that result from the deposit on the negative electrode, particularly because of the decomposition product of the electrolyte solution and the dissolution of the elements from the positive electrode active material, which are believed to be due to the above (I) and (II). Although the details will be discussed later, the latter effect, namely, the adverse effect on the separator and the negative electrode is believed to be significant, taking the present results into consideration.

In particular, in the batteries using a separator with a small pore volume (Comparative Batteries Z2 and Z3), it is believed that the separator performance considerably deteriorates when these side reaction products cause clogging even in small amounts, and moreover, the amount and rate of transfer of these reaction products from the positive electrode to the negative electrode are faster and greater. As a consequence, the degree of deterioration was greater. Accordingly, the degree of deterioration of the battery is believed to be dependent on the separator pore volume.

In Batteries A1 to A3 of the invention, each having a separator with the coating layer, the storage performance in a charged state improved. The reason is believed to be as follows. The decomposition products of the electrolyte solution and the Co or the like that has dissolved away from the positive electrode are trapped by the coating layer, which impedes the decomposition products and so forth from migrating to the separator and the negative electrode, causing deposition→reaction (deterioration), and clogging the separator. In other words, the coating layer exhibits a filtering function.

Many of water-insoluble binders for the coating layer expand about two times in volume after the electrolyte solution is filled, although it does not adversely affect the air permeability at the time of preparing the separator, so the gaps between the filler particles in the coating layer are filled up appropriately. This coating layer has a complicated, complex structure and the particles are firmly bonded to each other by the water-insoluble binder component. As a result, the strength is improved and the filtering effect can be exhibited sufficiently (i.e., the trapping effect becomes high since it has a complex structure even with a small thickness). The evaluation criteria for electrolyte solution absorbency is difficult to select, but it may be determined approximately by the time after dropping one drop of PC on the subject until the drop disappears.

Although the storage performance in a charged state may improve to a certain degree even when the filter layer is formed by a polymer layer only, the filtering effect will not be exhibited sufficiently unless the thickness of the polymer layer is sufficiently large, because the filtering effect in this case is dependent on the thickness of the polymer layer. Moreover, the filter capability weakens unless a completely non-porous structure is attained by the expansion of the polymer. Furthermore, the electrolyte solution permeability to the separator main body becomes poor because the entire surface of the separator main body is covered, so the adverse effects such as degradation in the load characteristics become greater. Therefore, in order to exert the filtering effect and at the same time minimize the adverse effects to other characteristics, it is more advantageous to form a filter layer containing filler particles (titanium oxide in the present example) rather than to form the filter layer by a polymer alone.

In view of the foregoing, the degree of deterioration is almost the same among the batteries provided with a separator having the coating layer, irrespective of the type of the separator main body, and possible causes of the deterioration may be changes in quality of the electrolyte solution and damages to the positive electrode itself.

Evidence Showing that the Improvement in the Storage Performance in a Charged State Results from the Filtering Effect

After completing the above-described test, the batteries were disassembled to observe the changes in color of the separators (separator main bodies) and the negative electrode surfaces. In the comparative batteries, in which no coating layer was formed, the separators discolored to a brownish color after storage in a charged state, and deposited substances were also observed on the negative electrodes. On the other hand, in the batteries of the invention, in which the coating layer was formed, neither discoloration nor deposited substance on the separator main body and the negative electrode surface was observed, but discoloration of the coating layer was observed. This result is believed to demonstrate that the reaction product at the positive electrode is hindered from migrating by the coating layer, whereby damages to the separator main body and the negative electrode are alleviated.

These reaction products are also likely to lead to cyclic side reactions such as self-discharge, in which the reaction products are reduced by migrating to the negative electrode and the subsequent reaction proceeds further. However, since the reaction products are trapped near the positive electrode, the cyclic reactions of the reaction products are hindered. In addition, it is possible that the reaction products themselves may serve the function similar to a surface film forming agent.

### (2) Analysis on the Separator Main Bodies

Batteries A1 to A3 of the invention, which uses the separator having the coating layer, achieve an improvement in storage performance in a charged state as described above, and the rate of the improvement is greater when the film thickness of the separator (separator main body) is thinner. Moreover, when the pore volume of separator (film thickness×porosity), which is one of separator's physical properties and is affected greatly by the film thickness, is used as an indicator, it is understood that the advantageous effects of the present invention become evident at about 800 (μm·%) or less, as shown in FIG. 2.

Here, in Comparative Batteries Z1 to Z6, which use a separator without the coating layer, the degree of deterioration during storage tends to be greater when the film thickness of the separator is thinner, although the film thickness of the separator does not completely correlate with the degree of deterioration. Generally, the separator needs to have such a degree of strength that it can ensure the insulation capability in the battery and also it can withstand the processes during the fabrication of the battery. When the film thickness of the separator is reduced, the strength of the film (such as tensile strength and penetration resistance) is lowered although the energy density of the battery is improved; therefore, the average pore size of the micropores needs to be reduced, and consequently the porosity reduces. On the other hand, when the film thickness of the separator is greater, the strength of the film can be ensured to a certain degree, so the average pore size and porosity of the micropores may be selected relatively freely.

Nevertheless, as mentioned above, an increase in the film thickness of the separator directly results in a decrease in the energy density of the battery. Therefore, it is generally preferred that the porosity is increased by increasing the average pore size while keeping a certain degree of thickness (usually about 20 μm). When the coating layer is provided while increasing the average pore size of the micropores, however, the defect rate of the battery tends to increase because of the entry of the filler particles in the micropores, as described above. Therefore, in reality, it is necessary to increase the porosity while at the same time reducing the pore size.

In view of these situations, we have conducted assiduous studies and found out that the separator on which the coating layer can be formed must meet the following three points: (I) it has a film thickness such that the energy density is ensured;

(II) The micropores of the separator have an average pore size that enables reduction of the battery defects resulting from the entry of the filler particles, which have come off from the coating layer formed on the positive electrode, into the micropores; and

(III) the separator main body must have a porosity such that an appropriate separator strength can be ensured.

From the foregoing conditions, we have found that the pore volume of the separator main body that can be used in the present invention is 1500 (unit: μm·%) or less, as determined by the expression: Film thickness×Porosity.

### (3) Conclusion

The foregoing results demonstrate that the storage performance in a charged state significantly improves in a 4.4 V battery having a separator provided with the coating layer, irrespective of the material of the separator main body. In particular, the advantageous effect is remarkable when the pore volume (film thickness×porosity) of the separator main body is 1500 (unit: μm·%) or less, more preferably 800 (unit: μm·%) or less.

### Second Group of Examples

The relationship between the end-of-charge voltage and the storage performance in a charged state was investigated by varying the end-of-charge voltage. Two types of separators (or separator main bodies in the cases of the batteries of the invention) were used, the filling density of the positive electrode active material layer was set at 3.60 g/cc, and the physical properties of the coating layer (the concentration of the water-insoluble binder with respect to titanium oxide and the thickness of the coating layer) formed on the surface of the separator main body were fixed. The results are set forth below.

### Example 1

A battery was fabricated in the same manner as described in Example 1 of the First Group of Examples, except that the battery was designed to have an end-of-charge voltage of 4.20 V and have a negative/positive electrode capacity ratio of 1.08 at that potential.

The battery fabricated in this manner is hereinafter referred to as Battery B1 of the invention.

### Example 2

A battery was fabricated in the same manner as described in Example 2 of the First Group of Examples, except that the battery was designed to have an end-of-charge voltage of 4.20 V and have a negative/positive electrode capacity ratio became 1.08 at that potential.

The battery fabricated in this manner is hereinafter referred to as Battery B2 of the invention.

### Example 3

A battery was fabricated in the same manner as described in Example 1 of the First Group of Examples, except that the battery was designed to have an end-of-charge voltage of 4.30 V and have a negative/positive electrode capacity ratio of 1.08 at that potential.

The battery fabricated in this manner is hereinafter referred to as Battery B3 of the invention.

### Example 4

A battery was fabricated in the same manner as described in Example 2 of the First Group of Examples, except that the battery was designed to have an end-of-charge voltage of 4.30 V and have a negative/positive electrode capacity ratio of 1.08 at that potential.

The battery fabricated in this manner is hereinafter referred to as Battery B4 of the invention.

### Example 5

A battery was fabricated in the same manner as described in Example 1 of the First Group of Examples, except that the battery was designed to have an end-of-charge voltage of 4.35 V and have a negative/positive electrode capacity ratio of 1.68 at that potential.

The battery fabricated in this manner is hereinafter referred to as Battery B5 of the invention.

### Example 6

A battery was fabricated in the same manner as described in Example 2 of the First Group of Examples, except that the battery was designed to have an end-of-charge voltage of 4.35 V and have a negative/positive electrode capacity ratio became 1.08 at that potential.

The battery fabricated in this manner is hereinafter referred to as Battery B6 of the invention.

### Comparative Examples 1 to 6

Batteries were fabricated in the same manner as described in Examples 1 to 6 above, except that no coating layer was formed on the separator.

The batteries fabricated in these manners are hereinafter referred to as

Comparative Batteries Y1 to Y6, respectively.

### (Experiment)

The storage performance in a charged state (the remaining capacity after storage in a charged state) was determined for each of Batteries B1 to B6 of the invention and Comparative Batteries Y1 to Y6. The results are shown in Tables 8 and 9 below. The tables also show the results for Batteries A1 and A2 of the invention and Comparative Batteries Z1 and Z2.

In addition, as representative examples, the charge-discharge characteristics of Comparative Battery Z2 and Battery A2 of the invention were compared. The characteristics of the former are shown in FIG. 3, and those of the latter are shown in FIG. 4.

The charge-discharge conditions and storage conditions were as follows.

[Charge-Discharge Conditions]

The charge-discharge conditions were the same as those in the experiment of the First Group of Examples.

Storage Conditions

Batteries A1, A2, and B3 to B6 of the invention and Comparative Batteries Z1, Z2, and Y3 to Y6 were set side under the same conditions as described in the experiment of the First Group of Examples. Batteries B1 and B2 of the invention and Comparative Batteries Y1 an Y2 were set aside at 80° C. for 4 days.

[Determination of Remaining Capacity]

The remaining capacities were calculated in the same manner as described in the experiment of the First Group of Examples.

TABLE 8

| | Separator | | | | | | |
|---|---|---|---|---|---|---|---|
| | | Separator main body | | | | | |
| | Total | | | | Pore volume | Coating layer | |
| | film | | | | [Film thickness × | | Concentration of titanium |
| Battery | thickness | Average pore size | Film thickness | Porosity | Porosity] | | with respect to acetone |
| (Separator) | (μm) | (μm) | (μm) | (%) | (μm %) | Formation | (mass %) |
| B1(IS1) | 20 | 0.6 | 18 | 45 | 81 | Yes | 10 |
| Comp. Y1 | 18 | | | | | No | — |
| (CS1) | | | | | | | |
| B2(IS4) | 14 | 0.1 | 12 | 38 | 456 | Yes | 10 |
| Comp. Y2 | 12 | | | | | No | — |
| (CS2) | | | | | | | |
| B3(IS1) | 20 | 0.6 | 18 | 45 | 810 | Yes | 10 |
| Comp. Y3 | 18 | | | | | No | — |
| (CS1) | | | | | | | |
| B4(IS4) | 14 | 0.1 | 12 | 38 | 456 | Yes | 10 |
| Comp. Y4 | 12 | | | | | No | — |
| (CS2) | | | | | | | |

| | Separator | | End-of-charge voltage | | | |
|---|---|---|---|---|---|---|
| | Coating layer | | (Positive electrode potential | Filling density | | |
| | Concentration of binder | Thickness | versus lithium reference | of positive electrode | Remaining | Abnormal |
| Battery | with respect to titanium | [both sides] | electrode potential) | active material layer | capacity | charge |
| (Separator) | oxide (mass %) | (μm) | (V) | (g/cc) | (%) | behavior |
| B1(IS1) | 10 | 2 | 4.20 | 3.60 | 82.1 | No |
| Comp. Y1 | — | — | (4.30) | | 76.5 | No |
| (CS1) | | | | | | |
| B2(IS4) | 10 | 2 | | | 80.3 | No |
| Comp. Y2 | — | — | | | 73.3 | No |
| (CS2) | | | | | | |
| B3(IS1) | 10 | 2 | 4.30 | | 85.9 | No |
| Comp. Y3 | — | — | (4.40) | | 74.2 | No |
| (CS1) | | | | | | |
| B4(IS4) | 10 | 2 | | | 82.5 | No |
| Comp. Y4 | — | — | | | 70.0 | Yes |
| (CS2) | | | | | | |

In each of Comparative Batteries Y1 to Y4, the separators are composed only of the separator main body since no coating layer is provided.

TABLE 9

| | Separator | | | | | | |
|---|---|---|---|---|---|---|---|
| | | Separator main body | | | | | |
| | Total | | | | Pore volume | Coating layer | |
| | film | | | | [Film thickness × | | Concentration of titanium |
| Battery | thickness | Average pore size | Film thickness | Porosity | Porosity] | | with respect to acetone |
| (Separator) | (μm) | (μm) | (μm) | (%) | (μm %) | Formation | (mass %) |
| B5 (IS1) | 20 | 0.6 | 18 | 45 | 810 | Yes | 10 |
| Comp. Y5 | 18 | | | | | No | — |
| (CS1) | | | | | | | |
| B6 (IS4) | 14 | 0.1 | 12 | 38 | 456 | Yes | 10 |
| Comp. Y6 | 12 | | | | | No | — |
| (CS2) | | | | | | | |
| A1 (IS1) | 20 | 0.6 | 18 | 45 | 810 | Yes | 10 |
| Comp. Z1 | 18 | | | | | No | — |
| (CS1) | | | | | | | |
| A2 (IS4) | 14 | 0.1 | 12 | 38 | 456 | Yes | 10 |
| Comp. Z2 | 12 | | | | | No | — |
| (CS2) | | | | | | | |

| | Separator | | End-of-charge voltage | | | |
|---|---|---|---|---|---|---|
| | Coating layer | | (Positive electrode potential | Filling density | | |
| | Concentration of binder | Thickness | versus lithium reference | of positive electrode | Remaining | Abnormal |
| Battery | with respect to titanium | [both sides] | electrode potential) | active material layer | capacity | charge |
| (Separator) | oxide (mass %) | (μm) | (V) | (g/cc) | (%) | behavior |
| B5 (IS1) | 10 | 2 | 4.35 | 3.60 | 83.3 | No |
| Comp. Y5 | — | — | (4.45) | | 70.4 | No |
| (CS1) | | | | | | |
| B6 (IS4) | 10 | 2 | | | 74.4 | No |
| Comp. Y6 | — | — | | | 0.1 | Yes |
| (CS2) | | | | | | |
| A1 (IS1) | 10 | 2 | 4.40 | | 68.9 | No |
| Comp. Z1 | — | — | (4.50) | | 45.5 | Yes |
| (CS1) | | | | | | |
| A2 (IS4) | 10 | 2 | | | 69.6 | No |
| Comp. Z2 | — | — | | | 0.1 | Yes |
| (CS2) | | | | | | |

In each of Comparative Batteries Z1, Z2, Y5, and Y6, the separators are composed only of the separator main body since no coating layer is provided.

### [Analysis]

As clearly seen from Tables 8 and 9, it is observed that in the storage test in a charged state, the Batteries of the invention, in which the coating layer is formed on the surface of the separator main body, exhibit significantly improved remaining capacities after storage in a charged state over the Comparative Batteries, in which no coating layer is formed, although the same types of separators (separator main bodies in the case of the batteries of the invention) are used (for example, when comparing Battery B1 of the invention and Comparative Battery Y1 and when comparing Battery B2 of the invention and Comparative Battery Y2). In particular, Comparative Batteries Y4, Y6, and Z2, in which the separator pore volume is less than 800 μm·% and the end-of-charge voltage is 4.30 V or higher, tend to show considerable deterioration in the storage performance in a charged state. In contrast, the storage performance in a charged state is hindered from deteriorating in Batteries B4, B6, and A2 of the invention, in which the coating layer is provided on the same separators as used in the respective Comparative Batteries.

In addition, as clearly seen from Table 8, it was confirmed that Comparative Batteries Y4, Y6, and Z2, in which the separator pore volume is less than 800 μm·% and the end-of-charge voltage is 4.30 V or higher, showed such a behavior that the charge curve meandered during the recharge after the remaining capacity had been confirmed and the amount of charge increased significantly (see a meandering portion 1 of FIG. 3, which shows the charge-discharge characteristics of Comparative Battery Z2). In contrast, such a behavior was not observed in Batteries B4, B6, and A2 of the invention, in which the coating layer was provided on the respective separators used in these Comparative Batteries (see FIG. 4, illustrating the charge-discharge characteristics of Battery A2 of the invention).

Further, those with a separator (separator main body) pore volume of greater than 800 μm·% were also studied. The above-described behavior was not observed in Comparative Batteries Y3 and Y5, in which the end-of-charge voltage is 4.30 V and 4.35 V, respectively, but the above-described behavior was observed in Comparative Battery Z1, in which the end-of-charge voltage is 4.40 V. In contrast, the above-described behavior was not observed in Batteries B3, B5, and A1 of the invention, in which the coating layer was provided on the same separator main bodies as used in the respective Comparative batteries. It should be noted that in the cases that the end-of-charge voltage was 4.20 V, the above-described behavior was not observed irrespective of the separator pore volume (not only in the case of Comparative Battery Y1 but also in the case of Comparative Battery Y2).

The foregoing results indicate that the less the pore volume of the separator (or the separator main body), the greater the degree of deterioration. It is also indicated that the higher the battery voltage during storage, the more significant the degree of deterioration. However, as far as the behaviors are compared between the battery with an end-of-charge voltage of 4.20 V and that with an end-of-charge voltage of 4.30 V, it is understood that they show greatly different modes of deterioration, and the degree of deterioration is clearly more noticeable at an end-of-charge voltage of 4.30 V.

The reason is thought to be as follows, although the following may still be a matter of speculation. It can be speculated that in the storage test with an end-of-charge voltage of 4.20 V, the burden on the structure of the positive electrode is not so great that the adverse effect resulting from the dissolution or the like of Co from the positive electrode may be negligible, although there is a little adverse effect due to the decomposition of the electrolyte solution. For this reason, the effect of improvement resulting from the presence of the coating layer accordingly remains somewhat low. In contrast, when the end-of-charge voltage (storage voltage) of the battery is higher, the stability of the crystal structure of the charged positive electrode becomes poorer, and moreover, the voltage becomes close to the limit of oxidation resistant potential of cyclic carbonates and chain carbonates, which are commonly used for lithium-ion batteries. Therefore, it can be speculated that the production of side reaction products and the decomposition of the electrolyte solution proceed more than expected with the voltages at which lithium-ion batteries have been used, and this consequently increases the damages to the negative electrode and the separator oxidized potential.

Although the details are not yet clear, the abnormal charge behavior is believed to be due to a kind of shuttle reaction (production of a shuttle substance as a side reaction product) originating from the highly oxidizing atmosphere or the failures in charge/discharge resulting from clogging of the separator (the oxidation-reduction reaction of the side reaction product produced at a battery voltage of 4.30 V or higher), not due to the electrical conduction caused by the deposition of Li, Co, Mn, etc., or the breakage of the separator, considering the fact that the behavior completely disappears after several cycles. This behavior is believed to be caused principally by the oxidation-reduction reaction between the positive electrode and the negative electrode, so an improvement for preventing the abnormal behavior is possible by hindering the reaction products or the like from migrating from the positive electrode to the negative electrode.

From the foregoing results, these advantageous effects are especially significant when the separator (separator main body) has a pore volume of 800 μm·% or less. Further, the effects are also significant when the battery voltage during storage is 4.30 V or higher (i.e., the positive electrode potential is 4.40 V or higher versus a lithium reference electrode potential), especially 4.35 V or higher (i.e., the positive electrode potential is 4.45 V or higher versus a lithium reference electrode potential), in that improvements in discharge working voltage, improvements in remaining/recovery ratio, and elimination of abnormal charge behavior are achieved.

### Third Group of Examples

The relationship between the physical properties of the coating layer and the storage performance in a charged state was investigated by varying the physical properties (the concentration of the water-insoluble binder with respect to titanium oxide and the thickness of the coating layer) of the coating layer formed on the surface of the separator main body. The end-of-charge voltage was set at 4.40 V, the filling density of the positive electrode active material layer was also set at 3.60 g/cc, and the same separator CS1 (the separator main body in the cases of the batteries of the invention) was used. The results are set forth below.

### Example 1

A battery was fabricated in the same manner as described in Example 1 of the First Group of Examples, except for the following. In the slurry used for forming the coating layer of the separator, the concentration of the solid content of titanium oxide was 10 mass % with respect to acetone, and the concentration of the water-insoluble binder was 2 mass % with respect to titanium oxide. In addition, the thickness of the coating layer on both sides was 1 μm in total.

The battery fabricated in this manner is hereinafter referred to as Battery C1 of the invention.

### Example 2

A battery was fabricated in the same manner as described in Example 1 of the First Group of Examples, except for the following. In the slurry used for forming the coating layer of the separator, the concentration of the solid content of titanium oxide was 10 mass % with respect to acetone, and the concentration of the water-insoluble binder was 30 mass % with respect to titanium oxide. In addition, the thickness of the coating layer on both sides was 4 μm in total.

The battery fabricated in this manner is hereinafter referred to as Battery C2 of the invention.

### (Experiment)

The storage performance in a charged state (the remaining capacity after storage in a charged state) was determined for Batteries C1 and C2 of the invention. The results are shown in Table 10 below. This table also shows the results for Battery A1 of the invention and Comparative Battery Z1.

The charge-discharge conditions, the storage conditions, and the method for determining the remaining capacity were the same as described in the experiment in the First Group of Examples.

TABLE 10

| | Separator | | | | | | |
|---|---|---|---|---|---|---|---|
| | | Separator main body | | | | Coating layer | |
| | Total film | | | | Pore volume [Film | | Concentration of titanium |
| Battery | thickness | Average pore size | Film thickness | Porosity | thickness × Porosity] | | with respect to acetone |
| (Separator) | (μm) | (μm) | (μm) | (%) | (μm %) | Formation | (mass %) |
| C1 (IS2) | 19 | 0.6 | 18 | 45 | 810 | Yes | 10 |
| A1 (IS1) | 20 | | | | | Yes | 10 |
| C2 (IS3) | 22 | | | | | Yes | 10 |
| Comp. Z1 | 18 | | | | | No | — |
| (CS1) | | | | | | | |

| | Separator | | | | |
|---|---|---|---|---|---|
| | Coating layer | | End-of-charge voltage | | |
| | Concentration of binder | | (Positive electrode potential | Filling density of positive | |
| | with respect to titanium | Thickness | versus lithium reference | electrode active material | |
| Battery | oxide | [both sides] | electrode potential) | layer | Remaining capacity |
| (Separator) | (mass %) | (μm) | (V) | (g/cc) | (%) |
| C1 (IS2) | 2 | 1 | 4.40 | 3.60 | 69.6 |
| A1 (IS1) | 10 | 2 | (4.50) | | 68.9 |
| C2 (IS3) | 30 | 4 | | | 69.4 |
| Comp. Z1 | — | — | | | 45.5 |
| (CS1) | | | | | |

In Comparative Battery Z1, the separator is composed only of the separator main body since no coating layer is provided.

### [Analysis]

The results in Table 10 clearly show that, in the storage test in a charged state, Batteries A1, C1, and C2 of the invention, in which the coating layer is formed on the surface of the separator main body, exhibited remarkable improvements in remaining capacity after storage in a charged state over Comparative Battery Z1, in which no coating layer is formed. In addition, when comparing Batteries A1, C1, and C2 of the invention with each other, it is observed that the thickness of the coating layer has almost no influence on the remaining capacity after storage in a charged state, although the effect slightly varies depending on the amount of the water-insoluble binder contained in the coating layer.

When considering the advantageous effect of the present invention, it is estimated that the filtering function becomes more significant when the thickness of the coating layer is greater or the concentration of the water-insoluble binder is higher. However, it is believed that there is a trade-off between the advantageous effect of the present invention and the resistance increase between the electrodes (which results from an increase of the distance and a consequent decrease of mobility of lithium ions). For example, although not shown in Table 10, it has been found that, when the concentration of the water-insoluble binder exceeds 50 mass % with respect to titanium oxide, the battery can be charged and discharged only to approximately half the design capacity, so the performance of the battery degrades considerably. This is believed to be because the water-insoluble binder filled up the gaps between the inorganic particles of the coating layer, so the mobility of lithium ions extremely lowered. When the amount of the water-insoluble binder is large as described above, the air permeability is believed to be considerably lowered even before the binder expands by absorbing the electrolyte solution.

Empirically, it is preferable to adjust the amount of the water-insoluble binder so that the measurement time of the air permeability test becomes 2.0 times or less, more preferably 1.5 times or less, and still more preferably 1.2 times or less, that of the separator without the coating layer. Even when the amount of the water-insoluble binder is 1 mass %, the water-insoluble binder is reasonably uniformly dispersed in the coating layer by the dispersion process such as the Filmics method. It has been found that even when the amount of the binder added is only 2 mass %, the function as a filter as well as a high bonding strength is exerted remarkably. It is preferable that the amount of the water-insoluble binder be as small as possible. However, when considering the physical strength for withstanding the processes of battery fabrication, the filtering effect, and sufficient dispersion capability of the inorganic particles in the slurry, it is preferable that the amount of the water-insoluble binder be controlled to be within the range of from 1 to 50 mass %, preferably from 1 to 10 mass %, and particularly preferably from 2 to 5 mass %.

On the other hand, it is preferable that the thickness of the coating layer be restricted to 2 μm or less per one side (4 μm or less per both sides), more preferably to 1 μm or less (2 μm or less per both sides), in order to prevent deteriorations of the load characteristics and the energy density of the battery.

### Fourth Group of Examples

The relationship between the filling density of the positive electrode active material layer and the storage performance in a charged state was investigated by varying the filling density of the positive electrode active material layer. The end-of-charge voltage was set at 4.40 V, the thickness of the coating layer was set at 2 μm, and the separators IS4 and CS2 were used for the batteries of the invention and Comparative Batteries, respectively. The results are as set forth below.

### Example 1

A battery was fabricated in the same manner as described in Example 2 of the First Group of Examples, except that the filling density of the positive electrode active material layer was set at 3.20 g/cc.

The battery fabricated in this manner is hereinafter referred to as Battery D1 of the invention.

### Example 2

A battery was fabricated in the same manner as described in Example 2 of the First Group of Examples, except that the filling density of the positive electrode active material layer was set at 3.40 g/cc.

The battery fabricated in this manner is hereinafter referred to as Battery D2 of the invention.

### Comparative Example 1

A battery was fabricated in the same manner as described in Comparative Example 2 of the First Group of Examples, except that the filling density of the positive electrode active material layer was set at 3.20 g/cc.

The battery fabricated in this manner is hereinafter referred to as Comparative Battery X1.

### Comparative Example 2

A battery was fabricated in the same manner as described in Comparative Example 2 of the First Group of Examples, except that the filling density of the positive electrode active material layer was set at 3.40 g/cc.

The battery fabricated in this manner is hereinafter referred to as Comparative Battery X2.

### Comparative Example 3

A battery was fabricated in the same manner as described in Comparative Example 2 of the First Group of Examples, except that the filling density of the positive electrode active material layer was set at 3.80 g/cc. The battery fabricated in this manner is hereinafter referred to as Comparative Battery X3.

### (Experiment)

The storage performance in a charged state (the remaining capacity after storage in a charged state) was determined for each of Batteries D1 and D2 of the invention as well as Comparative Batteries X1 to X3. The results are shown in Table 11 below. This table also shows the results for Battery A2 of the invention and Comparative Battery Z2.

The charge-discharge conditions, the storage conditions, and the method for determining the remaining capacity were the same as described in the experiment in the First Group of Examples.

TABLE 11

| | Separator | | | | | | |
|---|---|---|---|---|---|---|---|
| | | Separator main body | | | | Coating layer | |
| | Total film | | | | Pore volume [Film | | Concentration of titanium |
| Battery | thickness | Average pore size | Film thickness | Porosity | thickness × Porosity] | | with respect to acetone |
| (Separator) | (μm) | (μm) | (μm) | (%) | (μm %) | Formation | (mass %) |
| D1 (IS4) | 14 | 0.1 | 12 | 38 | 456 | Yes | 10 |
| Comp. X1 | 12 | | | | | No | — |
| (CS2) | | | | | | | |
| D2 (IS4) | 14 | | | | | Yes | 10 |
| Comp. X2 | 12 | | | | | No | — |
| (CS2) | | | | | | | |
| A2 (IS4) | 14 | | | | | Yes | 10 |
| Comp. Z2 | 12 | | | | | No | — |
| (CS2) | | | | | | | |
| Comp. X3 | 12 | | | | | No | — |
| (CS2) | | | | | | | |

| | Separator | | | | |
|---|---|---|---|---|---|
| | Coating layer | | End-of-charge voltage | | |
| | Concentration of binder | | (Positive electrode potential | Filling density of positive | |
| | with respect to titanium | Thickness | versus lithium reference | electrode active material | |
| Battery | oxide | [both sides] | electrode potential) | layer | Remaining capacity |
| (Separator) | (mass %) | (μm) | (V) | (g/cc) | (%) |
| D1 (IS4) | 10 | 2 | 4.40 | 3.20 | 74.3 |
| Comp. X1 | — | — | (4.50) | | 45.5 |
| (CS2) | | | | | |
| D2 (IS4) | 10 | 2 | | 3.40 | 71.2 |
| Comp. X2 | — | — | | | 0.1 |
| (CS2) | | | | | |
| A2 (IS4) | 10 | 2 | | 3.60 | 69.6 |
| Comp. Z2 | — | — | | | 0.1 |
| (CS2) | | | | | |
| Comp. X3 | — | — | | 3.80 | 0.1 |
| (CS2) | | | | | |

In each of Comparative Batteries Z2 and X1 to X3, the separator is composed only of the separator main body since no coating layer is provided.

As clearly seen from Table 11, when the positive electrode active material layer had a filling density of 3.20 g/cc, a certain degree of remaining capacity was obtained not only in Battery D1 of the invention but also in Comparative Battery X1. On the other hand, when the positive electrode active material layer had a filling density of 3.40 g/cc or greater, Batteries A2 and D2 of the invention exhibited a certain degree of remaining capacity but Comparative Batteries Z2, X2, and X3 showed very poor remaining capacity. This phenomenon is believed to be accounted for by the issue of the surface area of the positive electrode active material layer that comes in contact with the electrolyte solution and the degree of deterioration of the location where side reactions occur.

Specifically, when the filling density of the positive electrode active material layer is low (less than 3.40 g/cc), the deterioration proceeds uniformly over the entire region, not locally, so the deterioration does not significantly affect the charge-discharge reactions after storage. As a result, the capacity degradation is hindered not only in Battery D1 of the invention but also in Comparative Battery X1. In contrast, when the filling density is high (3.40 g/cc or higher), the deterioration takes place mainly in the outermost surface layer, so the entry and diffusion of lithium ions in the positive electrode active material during discharge become the rate-determining processes, and therefore, the degree of the deterioration is larger in Comparative Batteries Z2, X2, and X3. On the other hand, in Batteries A2 and D2 of the invention, the deterioration in the outermost surface layer is suppressed because of the presence of the coating layer, so the entry and diffusion of lithium ions in the positive electrode active material during discharge do not become the rate-determining processes, and the degree of the deterioration is smaller.

When the filling density of the negative electrode active material layer was varied from 1.30 g/cc to 1.80 g/cc while the filling density of the positive electrode active material layer was fixed, the results were not as significant as the case of varying the filling density of the positive electrode active material layer, and the performance was not dependent on the type of separator. Essentially, the side reaction products and dissolution substances produced on the positive electrode are trapped by the coating layer and are prevented from migrating to the separator and the negative electrode. Therefore, the advantageous effect is not dependent on the filling density of the negative electrode active material layer. The negative electrode merely contributes to reduction reactions of the by-products and dissolution substances, so various substances in addition to graphite may be used without limitation as long as the substances are capable of the oxidation-reduction reactions.

From the foregoing results, it is demonstrated that the advantageous effects of the present invention are particularly evident when the positive electrode active material layer has a filling density of 3.40 g/cc or greater. The filling density of the negative electrode and the type of the active material are not particularly limited.

### B. Examples Related to the Second Embodiment

### Fifth Group of Examples

The relationship between the physical properties of separator and the storage performance in a charged state was investigated by using various separators (or separator main bodies in the cases of the batteries of the invention). The end-of-charge voltage was fixed at 4.40 V, the filling density of the positive electrode active material layer was fixed at 3.60 g/cc, and the physical properties (the concentration of titanium oxide with respect to the total amount of the slurry, the concentration polymer, the CMC concentration, the surfactant concentration, and the thickness of the coating layer) of the coating layer formed on the surface of the separator main body were fixed. The results are set forth below.

### Example 1

A battery prepared in the manner described in the second embodiment was used for Example 1.

The battery fabricated in this manner is hereinafter referred to as Battery E1 of the invention.

### Example 2

A battery was fabricated in the same manner as described in Example 1 above, except that a separator main body having an average pore size of 0.1 μm, a film thickness of 12 μm, and a porosity of 38% was used as the separator main body. The total film thickness of the separator was 14 μm since the thickness of the coating layer on both sides was 2 μm in total.

The battery fabricated in this manner is hereinafter referred to as Battery E2 of the invention.

### Example 3

A battery was fabricated in the same manner as described in Example 1 above, except that a separator main body having an average pore size of 0.6 μm, a film thickness of 23 μm, and a porosity of 48% was used as the separator main body. The total film thickness of the separator was 25 μm since the thickness of the coating layer on both sides was 2 μm in total.

The battery fabricated in this manner is hereinafter referred to as Battery E3 of the invention.

### Comparative Example 1

A battery was fabricated in the same manner as described in Example 1 above, except that the coating layer of the separator was disposed on the positive electrode side of the separator.

The battery fabricated in this manner is hereinafter referred to as Comparative Battery W1.

### Comparative Example 2

A battery was fabricated in the same manner as described in Example 2 above, except that the coating layer of the separator was disposed on the positive electrode side of the separator.

The battery fabricated in this manner is hereinafter referred to as Comparative Battery W2.

### (Experiment)

The storage performance in a charged state (the remaining capacity after storage in a charged state) was determined for each of Batteries E1 to E3 of the invention and Comparative Batteries W1 and W2. The results are shown in Table 12 below. This table also shows the results for Comparative Batteries Z1 to Z6. Based on the results obtained, a study was conducted about correlation between the physical properties of the separator (separator main body) and the remaining capacity after storage in a charged state. The results are shown in FIG. 5. The charge-discharge conditions and the storage conditions were the same as those in the experiment described in the above First Group of Examples.

TABLE 12

| | Separator | | | | | | |
|---|---|---|---|---|---|---|---|
| | | | | | | Coating layer | |
| | | Separator main body | | | | | Concentration of |
| | | | | | Pore volume | | titanium oxide with |
| | | | | | [Film | | respect to total |
| Battery | Total film thickness | Average pore size | Film thickness | Porosity | thickness × Porosity] | Formation | amount of slurry |
| (Separator) | (μm) | (μm) | (μm) | (%) | (μm %) | (Location) | (mass %) |
| E1 (IS11) | 20 | 0.6 | 18 | 45 | 810 | Yes | 10 |
| E2 (IS15) | 14 | 0.1 | 12 | 38 | 456 | (Negative | |
| E3 (IS16) | 25 | 0.6 | 23 | 48 | 1104 | electrode | |
| | | | | | | side) | |
| Comp. W1 | 20 | 0.6 | 18 | 45 | 810 | Yes | |
| (CS11) | | | | | | (Positive | |
| Comp. W2 | 14 | 0.1 | 12 | 38 | 456 | electrode | |
| (CS12) | | | | | | side) | |
| Comp. Z1 | 18 | 0.6 | 18 | 45 | 810 | No | — |
| (CS1) | | | | | | | |
| Comp. Z2 | 12 | 0.1 | 12 | 38 | 456 | | |
| (CS2) | | | | | | | |
| Comp. Z3 | 16 | 0.1 | 16 | 47 | 752 | | |
| (CS3) | | | | | | | |
| Comp. Z4 | 20 | 0.05 | 20 | 38 | 760 | | |
| (CS4) | | | | | | | |
| Comp. Z5 | 23 | 0.6 | 23 | 48 | 1104 | | |
| (CS5) | | | | | | | |
| Comp. Z6 | 27 | 0.6 | 27 | 52 | 1404 | | |
| (CS6) | | | | | | | |

| | Separator | | | | | | |
|---|---|---|---|---|---|---|---|
| | Coating layer | | | | End-of-charge | | |
| | Concentration of | Concentration | Concentration of | | voltage (Positive | Filling density | |
| | copolymer with | of CMC with | surfactant with | | electrode potential | of positive | |
| | respect to total | respect to total | respect to total | Thickness | versus lithium reference | electrode active | Remaining |
| Battery | amount of slurry | amount of slurry | amount of slurry | [One side] | electrode potential) | material layer | capacity |
| (Separator) | (mass %) | (mass %) | (mass %) | (μm) | (V) | (g/cc) | (%) |
| E1 (IS11) | 1 | 1 | 1 | 2 | 4.40 | 3.60 | 80.2 |
| E2 (IS15) | | | | | (4.50) | | 80.8 |
| E3 (IS16) | | | | | | | 80.3 |
| Comp. W1 | | | | | | | 1.5 |
| (CS11) | | | | | | | |
| Comp. W2 | | | | | | | 0.0 |
| (CS12) | | | | | | | |
| Comp. Z1 | — | | | — | | | 45.5 |
| (CS1) | | | | | | | |
| Comp. Z2 | | | | | | | 0.1 |
| (CS2) | | | | | | | |
| Comp. Z3 | | | | | | | 12.2 |
| (CS3) | | | | | | | |
| Comp. Z4 | | | | | | | 30.2 |
| (CS4) | | | | | | | |
| Comp. Z5 | | | | | | | 47.3 |
| (CS5) | | | | | | | |
| Comp. Z6 | | | | | | | 50.2 |
| (CS6) | | | | | | | |

In each of Comparative Batteries Z1 to Z6, the separator is composed only of the separator main body since no coating layer is provided.
“Copolymer” means a copolymer containing an acrylonitrile structure (unit).

### [Analysis]

### (1) Analysis on the Advantage of the Provision of the Coating Layer

As clearly seen from the results shown in Table 12, although all the batteries has a design voltage of 4.40 V and the positive electrode active material layer having a filling density of 3.60 g/cc, Batteries E1 to E3 of the invention, in which the coating layer is formed on the negative electrode side, prove to show significant improvements in remaining capacity over Comparative Batteries Z1 to Z6, in which no coating layer was formed. The reason why such results of the experiment were obtained is believed to be as follows. As has been shown in the experiment of the First Group of Examples, the decomposition product of the electrolyte solution and the Co or the like that has dissolved away from the positive electrode are trapped by the coating layer, which impedes the decomposition product and so forth from migrating to the separator and the negative electrode, causing deposition→reaction (deterioration), and clogging the separator. In other words, the coating layer exhibits a filtering function.

In contrast, it is observed that Comparative Batteries W1 and W2, in which the coating layer is disposed on the positive electrode side, show lower remaining capacities than not only Batteries E1 to E3 of the invention, in which the coating layer is disposed on the negative electrode side, but also Comparative Batteries Z1 to Z6, in which no coating layer was disposed. This phenomenon is due to electrochemical stability of the surfactant and thickening agent (CMC) contained in the coating layer, and it is believed that these materials deteriorated in a highly oxidizing atmosphere originating from the positive electrode.

It has been confirmed that the water-insoluble binder used herein is electrochemically stable in CV profile, but generally, the use of water as a solvent tends to be less prone to oxidization. When water is used as the solvent, the above-mentioned binder agent, thickening agent, and surfactant are required in many cases. Currently, which of the three substances has a great influence on the cause of the oxidization (decomposition) is unclear, and there is a strong possibility that the influence is due to the combinations thereof. The specific decomposition potential is also unclear, but it has been found out that this tendency becomes stronger when the temperature is in the vicinity of 50° C. and when the positive electrode potential is 4.40 V or higher versus Li reference electrode potential, as far as various materials and conditions are considered.

In addition, the stability determined by cycle performance at 45° C. and 60° C. was also evaluated in addition to the storage performance, and similar tendencies were observed. Specifically, the batteries employing the separator in which the coating layer was formed on the negative electrode side exhibited the performance comparable to or higher than the batteries employing the separator in which no coating layer was formed. In contrast, the batteries employing the separator in which the coating layer was formed on the positive electrode side showed gas formation and capacity degradation resulting from the decomposition after several cycles. Nevertheless, even when the coating layer was formed on the positive electrode side, abnormality was not particularly observed by common battery performance evaluations (such as the performance evaluation under 25° C. conditions or the performance evaluation with the 4.2 V batteries).

### (2) Analysis on the Separator Main Bodies

Batteries E1 to E3 of the invention, which uses the separator having the coating layer, achieve an improvement in storage performance in a charged state as described above, and the rate of the improvement is greater when the film thickness of the separator (separator main body) is thinner. Moreover, when the pore volume of separator (film thickness×porosity), which is one of separator's physical properties and is affected greatly by the film thickness, is used as an indicator, it is understood that the advantageous effects of the present invention become sufficient at about 1500 (μm·%) or less, and the advantageous effects of the present invention become particularly evident at about 800 (μm·%) or less, as shown in FIG. 5. It is believed that this is due to the same reason as discussed in the experiment in the above First Group of Examples.

Accordingly, it is desirable that the pore volume (film thickness×porosity) of the separator main body be 1500 (unit: μm·%) or less, more desirably 800 (unit: μm·%) or less.

### Sixth Group of Examples

The relationship between the end-of-charge voltage and the storage performance in a charged state was investigated. Two types of separators (or separator main bodies in the cases of the batteries of the invention) were used, the filling density of the positive electrode active material layer was set at 3.60 g/cc, and the end-of-charge voltage was varied while the physical properties (the thickness of the coating layer and the concentrations of the titanium oxide, copolymer containing an acrylonitrile structure (unit), CMC, and surfactant with respect to the total amount of the slurry) of the coating layer formed on the surface of the separator main body were fixed. The results are set forth below.

### Example 1

A battery was fabricated in the same manner as described in Example 1 of the Fifth Group of Examples, except that the battery was designed to have an end-of-charge voltage of 4.20 V and have a negative/positive electrode capacity ratio of 1.08 at that potential.

The battery fabricated in this manner is hereinafter referred to as Battery F1 of the invention.

### Example 2

A battery was fabricated in the same manner as described in Example 2 of the Fifth Group of Examples, except that the battery was designed to have an end-of-charge voltage of 4.20 V and have a negative/positive electrode capacity ratio became 1.08 at that potential.

The battery fabricated in this manner is hereinafter referred to as Battery F2 of the invention.

### Example 3

A battery was fabricated in the same manner as described in Example 1 of the Fifth Group of Examples, except that the battery was designed to have an end-of-charge voltage of 4.30 V and have a negative/positive electrode capacity ratio of 1.08 at that potential.

The battery fabricated in this manner is hereinafter referred to as Battery F3 of the invention.

### Example 4

A battery was fabricated in the same manner as described in Example 2 of the Fifth Group of Examples, except that the battery was designed to have an end-of-charge voltage of 4.30 V and have a negative/positive electrode capacity ratio of 1.08 at that potential.

The battery fabricated in this manner is hereinafter referred to as Battery F4 of the invention.

### Example 5

A battery was fabricated in the same manner as described in Example 2 of the First Group of Examples, except that the battery was designed to have an end-of-charge voltage of 4.35 V and have a negative/positive electrode capacity ratio became 1.08 at that potential.

The battery fabricated in this manner is hereinafter referred to as Battery F5 of the invention.

### Comparative Example 1

A battery was fabricated in the same manner as described in Example 2 above, except that the coating layer of the separator was disposed on the positive electrode side of the separator.

The battery fabricated in this manner is hereinafter referred to as Comparative Battery V1.

### Comparative Example 2

A battery was fabricated in the same manner as described in Example 4 above, except that the coating layer of the separator was disposed on the positive electrode side of the separator.

The battery fabricated in this manner is hereinafter referred to as Comparative Battery V2.

### Comparative Example 3

A battery was fabricated in the same manner as described in Example 5 above, except that the coating layer of the separator was disposed on the positive electrode side of the separator.

The battery fabricated in this manner is hereinafter referred to as Comparative Battery V3.

### (Experiment)

The storage performance in a charged state (the remaining capacity after storage in a charged state) was determined for each of Batteries F1 to F5 of the invention and Comparative Batteries V1 to V3. The results are shown in Tables 13 and 14 below. Tables 13 and 14 also show the results for the above Batteries E1 and E2 of the invention and the above Comparative Batteries Y1 to Y6, W1, W2, Z1, and Z2.

The charge-discharge conditions and the storage conditions were the same as those in the experiment described in the above Second Group of Examples.

TABLE 13

| | Separator | | | | | | | |
|---|---|---|---|---|---|---|---|---|
| | | | | | | Coating layer | | |
| | Separator main body | | | | | | Concentration of | Concentration of |
| | | Average | | | | | titanium oxide with | copolymer with |
| | Total film | pore | Film | | Pore volume [Film | | respect to total | respect to total |
| Battery | thickness | size | thickness | Porosity | thickness × Porosity] | Formation | amount of slurry | amount of slurry |
| (Separator) | (μm) | (μm) | (μm) | (%) | (μm %) | (Location) | (mass %) | (mass %) |
| F1(IS11) | 20 | 0.6 | 18 | 45 | 810 | Yes (Negative | 10 | 1 |
| | | | | | | electrode side) | | |
| Comp. Y1 | 18 | | | | | No | — | — |
| (CS1) | | | | | | | | |
| F2 (IS15) | 14 | 0.1 | 12 | 38 | 456 | Yes (Negative | 10 | 1 |
| | | | | | | electrode side) | | |
| Comp. V1 | | | | | | Yes (Positive | | |
| (CS12) | | | | | | electrode side) | | |
| Comp. Y2 | 12 | | | | | No | — | — |
| (CS2) | | | | | | | | |
| F3 (IS11) | 20 | 0.6 | 18 | 45 | 810 | Yes (Negative | 10 | 1 |
| | | | | | | electrode side) | | |
| Comp. Y3 | 18 | | | | | No | — | — |
| (CS1) | | | | | | | | |
| F4 (IS15) | 14 | 0.1 | 12 | 38 | 456 | Yes (Negative | 10 | 1 |
| | | | | | | electrode side) | | |
| Comp. V2 | | | | | | Yes (Positive | | |
| (CS12) | | | | | | electrode side) | | |
| Comp. Y4 | 12 | | | | | No | — | — |
| (CS2) | | | | | | | | |

| | Separator | | | | | | |
|---|---|---|---|---|---|---|---|
| | Coating layer | | | | | | |
| | Concentration | Concentration of | | End-of-charge voltage | Filling density | | |
| | of CMC with | surfactant with | | (Positive electrode potential | of positive | | |
| | respect to total | respect to | Thickness | versus lithium reference | electrode active | Remaining | Abnormal |
| Battery | amount of slurry | total amount of slurry | [One side] | electrode potential) | material layer | capacity | charge |
| (Separator) | (mass %) | (mass %) | (μm) | (V) | (g/cc) | (%) | behavior |
| F1(IS11) | 1 | 1 | 2 | 4.20 | 3.60 | 83.6 | No |
| | | | | (4.30) | | | |
| Comp. Y1 | — | — | — | | | 76.5 | No |
| (CS1) | | | | | | | |
| F2 (IS15) | 1 | 1 | 2 | | | 82.4 | No |
| Comp. V1 | | | | | | 23.4 | No |
| (CS12) | | | | | | | |
| Comp. Y2 | — | — | — | | | 73.3 | No |
| (CS2) | | | | | | | |
| F3 (IS11) | 1 | 1 | 2 | 4.30 | | 88.8 | No |
| | | | | (4.40) | | | |
| Comp. Y3 | — | — | — | | | 74.2 | No |
| (CS1) | | | | | | | |
| F4 (IS15) | 1 | 1 | 2 | | | 86.4 | No |
| Comp. V2 | | | | | | 7.4 | No |
| (CS12) | | | | | | | |
| Comp. Y4 | — | — | — | | | 70.0 | Yes |
| (CS2) | | | | | | | |

In each of Comparative Batteries Y1 to Y4, the separator is composed only of the separator main body since no coating layer is provided.
“Copolymer” means a copolymer containing an acrylonitrile structure (unit).

TABLE 14

| | Separator | | | | | | | |
|---|---|---|---|---|---|---|---|---|
| | | | | | | Coating layer | | |
| | Separator main body | | | | | | Concentration of | Concentration of |
| | | Average | | | | | titanium oxide with | copolymer with |
| | Total film | pore | Film | | Pore volume [Film | | respect to total | respect to total |
| Battery | thickness | size | thickness | Porosity | thickness × Porosity] | Formation | amount of slurry | amount of slurry |
| (Separator) | (μm) | (μm) | (μm) | (%) | (μm %) | (Location) | (mass %) | (mass %) |
| Comp. | 18 | 0.6 | 18 | 45 | 810 | No | — | — |
| Y5(CS1) | | | | | | | | |
| F5 | 14 | 0.1 | 12 | 38 | 456 | Yes (Negative | 10 | 1 |
| (IS15) | | | | | | electrode side) | | |
| Comp. V3 | | | | | | Yes (Positive | | |
| (CS12) | | | | | | electrode side) | | |
| Comp. Y6 | 12 | | | | | No | — | — |
| (CS2) | | | | | | | | |
| E1 | 20 | 0.6 | 18 | 45 | 810 | Yes (Negative | 10 | 1 |
| (IS11) | | | | | | electrode side) | | |
| Comp. W1 | | | | | | Yes (Positive | | |
| (CS11) | | | | | | electrode side) | | |
| Comp. Z1 | 18 | | | | | No | — | — |
| (CS1) | | | | | | | | |
| E2 | 14 | 0.1 | 12 | 38 | 456 | Yes (Negative | 10 | 1 |
| (IS15) | | | | | | electrode side) | | |
| Comp. W2 | | | | | | Yes (Positive | | |
| (CS12) | | | | | | electrode side) | | |
| | 12 | | | | | No | — | — |

| | Separator | | | | | | |
|---|---|---|---|---|---|---|---|
| | Coating layer | | | | | | |
| | Concentration | Concentration of | | End-of-charge voltage | Filling density | | |
| | of CMC with | surfactant with | | (Positive electrode potential | of positive | | |
| | respect to total | respect to | Thickness | versus lithium reference | electrode active | Remaining | Abnormal |
| Battery | amount of slurry | total amount of slurry | [One side] | electrode potential) | material layer | capacity | charge |
| (Separator) | (mass %) | (mass %) | (μm) | (V) | (g/cc) | (%) | behavior |
| Comp. | — | — | — | 4.35 | 3.60 | 70.4 | No |
| Y5(CS1) | | | | (4.45) | | | |
| F5 | 1 | 1 | 2 | | | 81.9 | No |
| (IS15) | | | | | | | |
| Comp. V3 | | | | | | 0.1 | No |
| (CS12) | | | | | | | |
| Comp. Y6 | — | — | — | | | 0.1 | Yes |
| (CS2) | | | | | | | |
| E1 | 1 | 1 | 2 | 4.40 | | 80.2 | No |
| (IS11) | | | | (4.50) | | | |
| Comp. W1 | | | | | | 1.5 | No |
| (CS11) | | | | | | | |
| Comp. Z1 | — | — | — | | | 45.5 | Yes |
| (CS1) | | | | | | | |
| E2 | 1 | 1 | 2 | | | 80.8 | No |
| (IS15) | | | | | | | |
| Comp. W2 | | | | | | 0.0 | No |
| (CS12) | | | | | | | |
| | — | — | — | | | 0.1 | Yes |

In each of Comparative Batteries Y5, Y6, Z1, and Z2, the separator is composed only of the separator main body since no coating layer is provided.
“Copolymer” means a copolymer containing an acrylonitrile structure (unit).

### [Analysis]

As clearly seen from Tables 13 and 14, it is observed that in the storage test in a charged state, Batteries F1 to F5, E1 and E2 of the invention, in which the coating layer is formed on the negative electrode side of the separator main body, exhibit significantly improved remaining capacities after storage in a charged state over Comparative Batteries Y1 to Y6, Z1 and Z2, in which no coating layer is formed, although they use the same separators (separator main bodies in the cases of Batteries F1 to F5, E1 and E2 of the invention as well as Comparative Batteries V1 to V3, W1 and W2) (for example, when comparing Battery F1 of the invention and Comparative Battery Y1 and when comparing Battery F2 of the invention and Comparative Battery Y2). In particular, Comparative Batteries Y4, Y6, and Z2, in which the separator pore volume is less than 800 μm % and the end-of-charge voltage is 4.30 V or higher, tend to show considerable deterioration in the storage performance in a charged state. In contrast, the storage performance in a charged state is hindered from deteriorating in Batteries F4, F5, and E2 of the invention, in which the coating layer is provided on the negative electrode side of the same separators as used in the respective Comparative Batteries.

In addition, as clearly seen from Tables 13 and 14, it was confirmed that Comparative Batteries Y4, Y6, and Z2, in which the separator pore volume is less than 800 μm % and the end-of-charge voltage is 4.30 V or higher, showed such a behavior (abnormal charge behavior) that the charge curve meandered during the recharge after the remaining capacity had been confirmed and the amount of charge increased significantly (see a meandering portion 1 of FIG. 3, which shows the charge-discharge characteristics of Comparative Battery Z2). Further, those with a separator (separator main body) pore volume of greater than 800 μm·% were also studied. The above-described behavior was observed in Comparative Battery Z1, in which the end-of-charge voltage is 4.40 V. In contrast, the above-described behavior was not observed in Batteries F1 to F5, E1 and E2 of the invention, in which the coating layer was provided on the negative electrode side of the same separator main bodies as used in the respective Comparative batteries. It is believed that this is due to the same reason as discussed in the experiment in the above Second Group of Examples.

Also as clearly seen from Tables 13 and 14, it is observed that Batteries F2, F4, F5, E1, and E2 of the invention, in which the coating layer is formed on the negative electrode side of the separator main body, exhibit significantly improved remaining capacities after storage in a charged state over Comparative Batteries V1 to V3, W1, and W2, in which the coating layer is formed on the positive electrode side of the separator main body (for example, when comparing Battery F2 of the invention and Comparative Battery V1, and when comparing Battery F4 of the invention and Comparative Battery V2). In particular, Comparative Batteries V2, V3, W1, and W2, in which the end-of-charge voltage is 4.30 V or higher, tend to show considerable deterioration in the storage performance in a charged state. In contrast, the storage performance in a charged state is hindered from deteriorating in Batteries F4, F5, E1, and E2 of the invention. It is believed that this is due to the same reason as discussed in the experiment in the above Fifth Group of Examples.

From the foregoing results, these advantageous effects are especially significant when the separator (separator main body) has a pore volume of 800 μm·% or less. Further, the effects are also significant when the battery voltage during storage is 4.30 V or higher (i.e., the positive electrode potential is 4.40 V or higher versus a lithium reference electrode potential), especially 4.35 V or higher (i.e., the positive electrode potential is 4.45 V or higher versus a lithium reference electrode potential), in that improvements in discharge working voltage, improvements in remaining/recovery ratio, and elimination of abnormal charge behavior are achieved.

### Seventh Group of Examples

The relationship between the physical properties of the coating layer and the storage performance in a charged state was investigated by varying the physical properties (the concentration of the copolymer containing an acrylonitrile structure with respect to the total amount of the slurry) of the coating layer formed on the surface of the separator main body. The end-of-charge voltage was set at 4.40 V, the filling density of the positive electrode active material layer was also set at 3.60 g/cc, and the same separator CS1 (the separator main body in the cases of the batteries of the invention) was used. The results are set forth below.

### Example 1

A battery was fabricated in the same manner as described in Example 1 of the Fifth Group of Examples, except that the slurry used for forming the coating layer of the separator contained the copolymer containing an acrylonitrile structure in a concentration of 0.5 mass % with respect to the total amount of the slurry.

The battery fabricated in this manner is hereinafter referred to as Battery G1 of the invention.

### Example 2

A battery was fabricated in the same manner as described in Example 1 of the Fifth Group of Examples, except that the slurry used for forming the coating layer of the separator contained the copolymer containing an acrylonitrile structure in a concentration of 2 mass % with respect to the total amount of the slurry.

The battery fabricated in this manner is hereinafter referred to as Battery G2 of the invention.

### Example 3

A battery was fabricated in the same manner as described in Example 1 of the Fifth Group of Examples, except that the slurry used for forming the coating layer of the separator contained the copolymer containing an acrylonitrile structure in a concentration of 5 mass % with respect to the total amount of the slurry, and that the thickness of the coating layer was 3 μm.

The battery fabricated in this manner is hereinafter referred to as Battery G3 of the invention.

### (Experiment)

The storage performance in a charged state (the remaining capacity after storage in a charged state) was determined for Batteries G1 to G3 of the invention. The results are shown in Table 15 below. This table also shows the results for Battery E1 of the invention and Comparative Battery Z1.

The charge-discharge conditions, the storage conditions, and the method for determining the remaining capacity were the same as described in the experiment of the First Group of Examples.

TABLE 15

| | Separator | | | | | | |
|---|---|---|---|---|---|---|---|
| | | | | | | Coating layer | |
| | | Separator main body | | | | | Concentration of titanium |
| | | | | | Pore volume [Film | | oxide with respect to total |
| Battery | Total film thickness | Average pore size | Film thickness | Porosity | thickness × Porosity] | Formation | amount of slurry |
| (Separator) | (μm) | (μm) | (μm) | (%) | (μm %) | (Location) | (mass %) |
| G1 | 20 | 0.6 | 18 | 45 | 810 | Yes (Negative | 10 |
| (IS12) | | | | | | electrode side) | |
| E1 | | | | | | | |
| (IS11) | | | | | | | |
| G2 | | | | | | | |
| (IS13) | | | | | | | |
| G3 | | | | | | | |
| (IS14) | | | | | | | |
| Comp. Z1 | 18 | | | | | No | — |
| (CS1) | | | | | | | |

| | Separator | | | | | | |
|---|---|---|---|---|---|---|---|
| | Coating layer | | | | | | |
| | Concentration of | Concentration | Concentration of | | End-of-charge voltage | | |
| | copolymer with | of CMC with | surfactant with | | (Positive electrode | Filling density of | |
| | respect to total | respect to total | respect to total | Thickness | potential versus lithium | positive electrode | Remaining |
| Battery | amount of slurry | amount of slurry | amount of slurry | [One side] | reference electrode potential) | active material layer | capacity |
| (Separator) | (mass %) | (mass %) | (mass %) | (μm) | (V) | (g/cc) | (%) |
| G1 | 0.5 | 1 | 1 | 2 | 4.40 | 3.60 | 79.8 |
| (IS12) | | | | | (4.50) | | |
| E1 | 1 | | | | | | 80.2 |
| (IS11) | | | | | | | |
| G2 | 2 | | | | | | 80.1 |
| (IS13) | | | | | | | |
| G3 | 5 | | | 3 | | | 79.4 |
| (IS14) | | | | | | | |
| Comp. Z1 | — | — | — | — | | | 45.5 |
| (CS1) | | | | | | | |

In Comparative Battery Z1, the separator is composed only of the separator main body since no coating layer is provided.
“Copolymer” means a copolymer containing an acrylonitrile structure (unit).

### [Analysis]

The results in Table 15 clearly show that, in the storage test in a charged state, Batteries E1 and G1 to G3 of the invention, in which the coating layer is formed on the negative electrode side of the separator main body, exhibited remarkable improvements in remaining capacity after storage in a charged state over Comparative Battery Z1, in which no coating layer is formed. In addition, when comparing Batteries E1 and G1 to G3 of the invention with each other, it is observed that the concentration of the copolymer containing an acrylonitrile structure (water-insoluble binder) with respect to the total amount of the slurry and the thickness of the coating layer have almost no influence on the remaining capacity after storage in a charged state.

Here, an increase of the resistance between the electrodes (which results from an increase of the distance and a consequent decrease of mobility of lithium ions) arises as the thickness of the coating layer is greater or the concentration of the water-insoluble binder is higher. For this reason, it is preferable that the concentration of the copolymer containing an acrylonitrile structure (water-insoluble binder) be 10 mass % or less, desirably 5 mass % or less, and particularly desirably 3 mass % or less, with respect to the total amount of the solid content (the total amount of titanium oxide, the copolymer containing an acrylonitrile structure, the CMC, and the surfactant).

On the other hand, it is preferable that the thickness of the coating layer be restricted to 4 μm or less, more preferably to 2 μm or less, in order to prevent deteriorations of the load characteristics and the energy density of the battery. It has been confirmed that the advantageous effects of the present invention are obtained even when the thickness of the coating layer is as thin as about 1 μm.

### Eighth Group of Examples

The relationship between the filling density of the positive electrode active material layer and the storage performance in a charged state was investigated by varying the filling density of the positive electrode active material layer. The end-of-charge voltage was set at 4.40 V, the thickness of the coating layer was set at 2 μm, and the separators IS15 and CS2 were used for the Batteries of the invention and Comparative Batteries, respectively. The results are as set forth below.

### Example 1

A battery was fabricated in the same manner as described in Example 2 of the Fifth Group of Examples, except that the filling density of the positive electrode active material layer was set at 3.20 g/cc.

The battery fabricated in this manner is hereinafter referred to as Battery H1 of the invention.

### Example 2

A battery was fabricated in the same manner as described in Example 2 of the Fifth Group of Examples, except that the filling density of the positive electrode active material layer was set at 3.40 g/cc.

The battery fabricated in this manner is hereinafter referred to as Battery H2 of the invention.

### (Experiment)

The storage performance in a charged state (remaining capacity after storage in a charged state) was determined for Batteries H1 and H2 of the invention. The results are shown in Table 16 below. This table also shows the results for the above Battery E2 of the invention and the above Comparative Batteries Z2, X1 to X3, and W2.

The charge-discharge conditions, the storage conditions, and the method for determining the remaining capacity were the same as described in the experiment in the First Group of Examples.

TABLE 16

| | Separator | | | | | | |
|---|---|---|---|---|---|---|---|
| | | | | | | Coating layer | |
| | | Separator main body | | | | | Concentration of titanium |
| | | | | | Pore volume [Film | | oxide with respect to total |
| Battery | Total film thickness | Average pore size | Film thickness | Porosity | thickness × Porosity] | Formation | amount of slurry |
| (Separator) | (μm) | (μm) | (μm) | (%) | (μm %) | (Location) | (mass %) |
| H1 | 14 | 0.1 | 12 | 38 | 456 | Yes (Negative | 10 |
| (IS15) | | | | | | electrode side) | |
| Comp. X1 | 12 | | | | | No | — |
| (CS2) | | | | | | | |
| H2 | 14 | | | | | Yes (Negative | 10 |
| (IS15) | | | | | | electrode side) | |
| Comp. X2 | 12 | | | | | No | — |
| (CS2) | | | | | | | |
| E2 | 14 | | | | | Yes (Negative | 10 |
| (IS15) | | | | | | electrode side) | |
| Comp. W2 | 14 | | | | | Yes (Positive | |
| (CS12) | | | | | | electrode side) | |
| Comp. Z2 | 12 | | | | | No | — |
| (CS2) | | | | | | | |
| Comp. X3 | 12 | | | | | No | — |
| (CS2) | | | | | | | |

| | Separator | | | | | | |
|---|---|---|---|---|---|---|---|
| | Coating layer | | | | | | |
| | Concentration of | Concentration | Concentration of | | End-of-charge voltage | | |
| | copolymer with | of CMC with | surfactant with | | (Positive electrode | Filling density of | |
| | respect to total | respect to total | respect to total | Thickness | potential versus lithium | positive electrode | Remaining |
| Battery | amount of slurry | amount of slurry | amount of slurry | [One side] | reference electrode potential) | active material layer | capacity |
| (Separator) | (mass %) | (mass %) | (mass %) | (μm) | (V) | (g/cc) | (%) |
| H1 | 1 | 1 | 1 | 2 | 4.40 | 3.20 | 80.4 |
| (IS15) | | | | | (4.50) | | |
| Comp. X1 | — | — | — | — | | | 45.5 |
| (CS2) | | | | | | | |
| H2 | 1 | 1 | 1 | 2 | | 3.40 | 81.2 |
| (IS15) | | | | | | | |
| Comp. X2 | — | — | — | — | | | 0.1 |
| (CS2) | | | | | | | |
| E2 | 1 | 1 | 1 | 2 | | 3.60 | 80.8 |
| (IS15) | | | | | | | |
| Comp. W2 | | | | | | | 0.0 |
| (CS12) | | | | | | | |
| Comp. Z2 | — | — | — | — | | | 0.1 |
| (CS2) | | | | | | | |
| Comp. X3 | — | — | — | — | | 3.80 | 0.1 |
| (CS2) | | | | | | | |

In each of Comparative Batteries X1 to X3, and Z2, the separator is composed only of the separator main body since no coating layer is provided.
“Copolymer” means a copolymer containing an acrylonitrile structure (unit).

As clearly seen from Table 16, when the positive electrode active material layer had a filling density of 3.20 g/cc, a certain degree of remaining capacity was obtained not only in Battery H1 of the invention but also in Comparative Battery X1. On the other hand, when the positive electrode active material layer had a filling density of 3.40 g/cc or greater, Batteries H2 and E2 of the invention exhibited a certain degree of remaining capacity but Comparative Batteries Z2, X2, and X3 showed very poor remaining capacity. This phenomenon is believed to be accounted for by the surface area of the positive electrode active material layer that comes in contact with the electrolyte solution and the degree of deterioration of the location where side reactions occur. The specific reasons are believed to be the same as discussed in the experiment of the above Fourth Group of Examples.

From the foregoing results, it is demonstrated that the advantageous effects of the present invention are particularly evident when the positive electrode active material layer has a filling density of 3.40 g/cc or greater. The filling density of the negative electrode and the type of the active material are not particularly limited, however.

### C. Examples Related to the Third Embodiment

### Ninth Group of Examples

The relationship of the storage performance in a charged state with whether or not LiBF₄ was added and whether or not the coating layer is present was investigated. The end-of-charge voltage was set at 4.40 V, and the separators IS17 and CS2 were used for the Battery of the invention and Comparative Batteries, respectively. The results are as set forth below.

### Example

A battery prepared in the manner described in the above third embodiment of the best mode was used for this Example.

The battery fabricated in this manner is hereinafter referred to as Battery J of the invention.

### Comparative Example 1

A battery was fabricated in the same manner as described in Example above, except that LiBF₄ was not added to the electrolyte solution. The battery fabricated in this manner is hereinafter referred to as Comparative Battery V1.

### Comparative Example 2

A battery was fabricated in the same manner as described in Example above, except that no coating layer was formed on the surface of the separator main body. The battery fabricated in this manner is hereinafter referred to as Comparative Battery V2.

### Comparative Example 3

A battery was fabricated in the same manner as described in Example above, except that LiBF₄ was not added to the electrolyte solution and that no coating layer was formed on the surface of the separator main body.

The battery fabricated in this manner is hereinafter referred to as Comparative Battery V3.

### (Experiment)

The storage performance in a charged state (the remaining capacity after storage in a charged state) was determined for each of Battery J of the invention as well as Comparative Batteries V1 to V3. The results are shown in Table 17 below. The charge-discharge conditions and storage conditions were as follows.

### [Charge-DISCHARGE CONDITIONS]

Charge Conditions

Each of the batteries was charged at a constant current of 1.0 It (750 mA) until the battery voltage reached a predetermined voltage (i.e., the above-described end-of-charge voltage, 4.40 V for all the batteries in the present experiment [equivalent to a positive electrode potential of 4.50 V versus a lithium reference electrode]), and thereafter charged at the predetermined voltage until the current value reached 1/20 It (37.5 mA).

Discharge Conditions

Each of the batteries was discharged at a constant current of 1.0 It (750 mA) until the battery voltage reached 2.75 V.

The interval between the charge and the discharge was 10 minutes.

### [Storage Conditions]

Each of the batteries was charged and discharged one time according to the above-described charge-discharge conditions, and was again charged according to the charge conditions specified above to the predetermined voltage. Then, each of the charged batteries was set aside at 60° C. for 5 days.

### [Determination of Remaining Capacity]

Each of the batteries was cooled to room temperature and discharged under the same conditions as the above-described discharge conditions, to measure the remaining capacity. Using the discharge capacity obtained at the first time discharge after the storage test and the discharge capacity obtained before the storage test, the remaining capacity was calculated using the following equation (4).

Remaining capacity (%)=(Discharge capacity obtained at the first-time discharge after storage test/Discharge capacity obtained before storage test)×100 (4)

TABLE 17

| | | | | | | | | | End-of-charge | |
|---|---|---|---|---|---|---|---|---|---|---|
| | | | | | | | | | voltage | |
| | | | | | | | | | (Positive | |
| | | | | | | | | | electrode | |
| | Separator | | | | | | LiBF₄ | | potential versus | |
| | Separator main body | | | | | | | Amount with | lithium | |
| | | | | Pore volume | | | | respect to | reference | |
| | Average | Film | | [Film thickness × | | | | total mass of | electrode | Remaining |
| Battery | pore size | thickness | Porosity | Porosity] | Coating layer | | | electrolyte | potential) | capacity |
| (Separator) | (μm) | (μm) | (%) | (μm %) | Formation | Location | Addition | solution | (V) | (%) |
| J | 0.1 | 12 | 38 | 456 | Yes | Separator | Yes | 1 mass % | 4.40 | 72.7 |
| (IS17) | | | | | | surface | | | (4.50) | |
| Comp. V1 | | | | | Yes | (Surface of | No | — | | 59.6 |
| (IS17) | | | | | | Positive | | | | |
| | | | | | | electrode side) | | | | |
| Comp. V2 | | | | | No | — | Yes | 1 mass % | | 62.0 |
| (CS2) | | | | | | | | | | |
| Comp. V3 | | | | | No | | No | — | | 0.1 |
| (CS2) | | | | | | | | | | |

In each of Comparative Batteries V2 and V3, the separator is composed only of the separator main body since no coating layer is provided.

As clearly seen from Table 17, it is observed that Battery J of the invention, in which the coating layer was formed on the surface of the separator main body and also LiBF₄ was added to the electrolyte solution, exhibited a greater remaining capacity (i.e., higher storage performance in a charged state) than Comparative Batteries V1, in which LiBF₄ was added but no coating layer was formed on the surface of the separator main body, Comparative Battery V2, in which LiBF₄ was added to the electrolyte solution but no coating layer was formed on the surface of the separator main body, and Comparative Battery V3, in which no LiBF₄ was added to the electrolyte solution and no coating layer was formed on the surface of the separator main body.

This is believed to be due to the following two reasons.

### (1) LiBF₄ is Added to the Electrolyte Solution

First, when comparing the batteries in which no coating layer is formed on the surface of the positive electrode side of the separator main body (i.e., Comparative Batteries V2 and V3) with each other, it is observed that Comparative Battery V2, in which LiBF₄ is added to the electrolyte solution, shows a greater remaining capacity than Comparative Battery V3, in which no LiBF₄ is added to the electrolyte solution. Likewise, when comparing the batteries in which the coating layer is formed on the separator main body (Battery J of the invention and Comparative Battery V1) with each other, Battery J of the invention, in which LiBF₄ is added to the electrolyte solution, shows a greater remaining capacity than Comparative Battery V1, in which LiBF₄ is not added to the electrolyte solution. This is believed to be due to the following reason.

First, possible causes of the deterioration in storage performance in a charged state will be considered. There are several possible cases, but the primary causes are believed to be as follows, taking into consideration that the positive electrode active material is used up to about 4.5 V versus the lithium reference electrode (the battery voltage is 0.1 V lower than that, i.e., about 4.4 V).

(I) The decomposition of the electrolyte solution in a strong oxidizing atmosphere due to the higher charge potential of the positive electrode.
(II) The deterioration due to the structure of the charged positive electrode active material that becomes unstable.

Not only do these bring about the deteriorations of the positive electrode and the electrolyte solution but also affect the clogging of the separator and the deterioration of the negative electrode active material that results from the deposit on the negative electrode, particularly because of the decomposition product of the electrolyte solution and the dissolution of the elements from the positive electrode active material, which are believed to be due to the above (I) and (II).

When LiBF₄ is added to the electrolyte solution as described above, a surface film originating from the LiBF₄ is formed on the surface of the positive electrode active material. Thus, the presence of the surface film serves to hinder dissolution of the substances constituting the positive electrode active material (Co ions and Mn ions) and decomposition of the electrolyte solution on the positive electrode surface. As a result, the storage performance in a charged state is hindered from deteriorating.

### (2) The Coating Layer is Formed

First, when comparing the batteries in which LiBF₄ is not added to the electrolyte solution (i.e., Comparative Batteries V1 and V3) with each other, it is observed that Comparative Battery V1, in which the coating layer is formed on the separator main body, shows a greater remaining capacity than Comparative Battery V3, in which no coating layer is formed on the separator main body. Likewise, when comparing the batteries in which LiBF₄ is added to the electrolyte solution (Battery J of the invention and Comparative Battery V2) with each other, Battery J of the invention, in which the coating layer is formed on the separator main body, shows a greater remaining capacity than Comparative Battery V2, in which no coating layer is formed on the separator main body. This is believed to be due to the following reason.

When the electrolyte solution contains LiBF₄ as described above, a surface film originating from the LiBF₄ is formed on the surface of the positive electrode active material. Nevertheless, it is difficult to cover the positive electrode active material completely with the surface film originating from LiBF₄, so it is difficult to prevent the dissolution of the substances constituting the positive electrode active material and the decomposition of the electrolyte solution on the positive electrode surface sufficiently.

In view of this, when the coating layer is formed on the separator main body as described above, the decomposition products of the electrolyte solution and the Co ions, for example, that have dissolved away from the positive electrode are trapped by the coating layer, which impedes the decomposition products and so forth from migrating to the separator and the negative electrode, causing deposition reaction (deterioration), and clogging the separator. In other words, the coating layer exhibits a filtering function so that the Co or the like is prevented from being deposited on the negative electrode. As a result, it is believed that the batteries having the coating layer show improvements in storage performance in a charged state over the batteries in which no coating layer is formed.

It should be noted that many of water-insoluble binders for the coating layer expand about two times in volume at the time of preparing the separator after the electrolyte solution is filled, although it does not adversely affect the air permeability, so the gaps between the inorganic particles in the coating layer are filled up appropriately. This coating layer has a complicated, complex structure and the inorganic particles are firmly bonded to each other by the binder component. As a result, the strength is improved and the filtering effect can be exhibited sufficiently (i.e., the trapping effect becomes high since it has a complex structure even with a small thickness).

Although the storage performance in a charged state may improve to a certain degree even when the filter layer is formed by a polymer layer only, the filtering effect will not be exhibited sufficiently unless the thickness of the polymer layer is sufficiently large, because the filtering effect in this case is dependent on the thickness of the polymer layer. Moreover, the filter capability weakens unless a completely non-porous structure is attained by the expansion of the polymer. Furthermore, adverse effects tend to be greater, such as degradation in the electrolyte solution permeability to the negative electrode and deterioration of the load characteristics. Therefore, in order to exert the filtering effect and at the same time minimize the adverse effects on other characteristics, it is more advantageous to form a coating layer (filter layer) containing filler particles (titanium oxide in the present example) rather than to form the filter layer by a polymer alone.

### (3) Conclusion

From the foregoing (1) and (2), it is believed that Battery J of the invention achieves a remarkable improvement in storage performance in a charged state by the synergistic effect of the following. The addition of LiBF₄ to the electrolyte solution exerts the effect of hindering the substances that constitute the positive electrode active material (such as Co ions and Mn ions) from dissolving away and the effect of hindering the electrolyte solution from decomposing on the positive electrode surface. Moreover, the formation of the coating layer on the surface of the separator main body exerts the filtering effect.

### (4) Matters Relating to the Present Examples

Amount of LiBF₄ to be Added

Although not described in the foregoing experiment, the following was found out about the amount of LiBF₄ to be added.

When the amount of LiBF₄ added is too large, the surface film formed on the positive electrode surface becomes too thick since LiBF₄ has high reactivity, and moreover, a surface film originating from LiBF₄ is also formed on the negative electrode surface. Therefore, the Li intercalation and deintercalation do not take place smoothly, resulting in the initial capacity. On the other hand, when the amount of LiBF₄ added is too small, it is difficult to prevent the dissolution of the substances constituting the positive electrode active material and the decomposition of the electrolyte solution on the positive electrode surface sufficiently, although the initial capacity is prevented from deteriorating. Thus, the effect of improving storage performance in a charged state becomes small. For this reason, it is important to control the thickness of the surface film on the positive electrode surface and the negative electrode surface by restricting the amount of LiBF₄ added.

In order to improve the storage performance in a charged state without degrading the initial performance, it is important to control the thickness of the surface film on the positive electrode surface and the negative electrode surface by controlling the lithium salt concentration and the amount of added LiBF₄ appropriately and to suppress the dissolution substances from the positive electrode and the decomposition products of the electrolyte solution to a degree such that they can be trapped by the coating layer. Bearing the foregoing in mind, the present inventors conducted a study and as a result found that it is preferable to control the amount of LiBF₄ from 0.1 mass % to 5.0 mass % with respect to the total amount of the non-aqueous electrolyte in the case that the concentration of LiPF₆ in the electrolyte solution is controlled to be in the range of from 0.6 M to 2.0 M. Thereby, while the initial performance degradation resulting from the surface film formed by the addition of LiBF₄ is prevented, the dissolution substances and the decomposition products are impeded to such a degree that they can be trapped by the coating layer. As a result, the storage performance in a charged state improves remarkably.

End-of-Charge Voltage (Positive Electrode Potential Versus a Lithium Reference Electrode)

Although not described in the foregoing experiment, the following was revealed about the end-of-charge voltage (positive electrode potential with respect to a lithium reference electrode).

In the case that the end-of-charge voltage is 4.30 V (the positive electrode potential is 4.40 V versus a lithium reference electrode), the burden on the structure of the positive electrode is not so great that the dissolution of Co ions and Mn ions from the positive electrode is little and the amount of the reaction products produced by the decomposition of the electrolyte solution or the like is also small. On the other hand, LiBF₄ has the advantage of forming a surface film on the positive electrode surface and is thereby capable of hindering, for example, dissolution substances from the positive electrode active material and decomposition of the electrolyte solution. Nevertheless, LiBF₄ has a drawback of reducing the concentration of the lithium salt and reducing the conductivity of the electrolyte solution because LiBF₄ is highly reactive with the positive electrode. For this reason, if LiBF₄ is added even in the case that the adverse effects of the dissolution of Co ions from the positive electrode or the like are small, the advantage of addition of LiBF₄ is superseded by the drawback of addition of LiBF₄.

When the end-of-charge voltage is 4.30 V (the positive electrode potential is 4.40 V versus a lithium reference electrode) or higher, the crystal structure of the charged positive electrode becomes unstable, and moreover the voltage becomes close to the limit of oxidation resistant potential of cyclic carbonates and chain carbonates, which are commonly used in the lithium-ion batteries. As a consequence, the dissolution of Co ions or the like and the decomposition of the electrolyte solution proceed to a greater degree than is expected with the voltages at which non-aqueous electrolyte secondary batteries have been used. In such a case, the addition of LiBF₄ and the formation of the coating layer are worthwhile.

Specifically, when LiBF₄ is added in such a case as described above, the advantageous effect can be exhibited sufficiently that the formation of the surface film originating from LiBF₄ on the positive electrode surface impedes the dissolution of Co ions and Mn ions from the positive electrode and the decomposition of the electrolyte solution. In other words, the advantage is exhibited such that the above-mentioned drawback of addition of LiBF₄ is superseded.

From the foregoing, it is preferable that LiBF₄ be added to the electrolyte solution when the end-of-charge voltage is 4.30 V or higher (the positive electrode potential of 4.40 V or higher versus the lithium reference electrode).

Nevertheless, only the addition of LiBF₄ still brings about deterioration of the remaining capacity after storage because Co ions and Mn ions dissolve away in a small amount from the positive electrode active material or the decomposition of the electrolyte solution or the like occurs. In view of this, the coating layer is formed on the surface of the separator main body so that the reaction products or the like that cannot be stopped completely by the surface film originating from LiBF₄ can be trapped completely by the coating layer, which impedes the reaction products and the like from migrating to the separator and the negative electrode, causing deposition→reaction (deterioration), and clogging the separator. Thereby the storage performance in a charged state can be improved remarkably.

### Tenth Group of Examples

The relationship of the storage performance in a charged state with whether or not LiBF₄ was added and whether or not the coating layer is present was investigated. The end-of-charge voltage was 4.40 V, and the separators IS18 and CS3 were used for the battery of the invention and the comparative batteries, respectively. The results are as set forth below.

### Example

A battery was fabricated in the same manner as described in Example of the Ninth Group of Examples, except that a separator main body having an average pore size of 0.1 μm, a film thickness of 16 μm, and a porosity of 47% was used as the separator main body, that the coating layer was provided on the surface of the negative electrode side of the separate main body, and that the amount of the LiBF₄ was 3 mass % with respect to the total mass of the electrolyte solution.

The battery fabricated in this manner is hereinafter referred to as Battery K of the invention.

### Comparative Example 1

A battery was fabricated in the same manner as described in Example above, except that no coating layer was formed on the surface of the separator main body.

The battery fabricated in this manner is hereinafter referred to as Comparative Battery U1.

### Comparative Example 2

A battery was fabricated in the same manner as described in Example above, except that no coating layer was formed on the surface of the separator main body and that LiBF₄ was not added to the electrolyte solution.

The battery fabricated in this manner is hereinafter referred to as Comparative Battery U2.

### (Experiment)

The storage performance in a charged state (the remaining capacity after storage in a charged state) was determined for each of Battery K of the invention and Comparative Batteries U1 and U2. The results are shown in Table 18.

The charge-discharge conditions, the storage conditions, and the method for determining the remaining capacity were the same as described in the experiment in the Ninth Group of Examples.

TABLE 18

| | | | | | | | | | End-of-charge | |
|---|---|---|---|---|---|---|---|---|---|---|
| | | | | | | | | | voltage | |
| | | | | | | | | | (Positive | |
| | | | | | | | | | electrode | |
| | Separator | | | | | | LiBF₄ | | potential versus | |
| | Separator main body | | | | | | | Amount with | lithium | |
| | | | | Pore volume | | | | respect to | reference | |
| | Average | Film | | [Film thickness × | | | | total mass of | electrode | Remaining |
| Battery | pore size | thickness | Porosity | Porosity] | Coating layer | | | electrolyte | potential) | capacity |
| (Separator) | (μm) | (μm) | (%) | (μm %) | Formation | Location | Addition | solution | (V) | (%) |
| K | 0.1 | 16 | 47 | 752 | Yes | Separator | Yes | 3 mass % | 4.40 | 71.7 |
| (IS18) | | | | | | surface | | | (4.50) | |
| | | | | | | (Surface of | | | | |
| | | | | | | negative | | | | |
| | | | | | | electrode side) | | | | |
| Comp. U1 | | | | | No | — | Yes | 3 mass % | | 69.2 |
| (CS3) | | | | | | | | | | |
| Comp. U2 | | | | | | | No | — | | 16.4 |
| (CS3) | | | | | | | | | | |

In each of Comparative Batteries U1 and U2, the separator is composed only of the separator main body since no coating layer is provided.

### [Analysis]

As clearly seen from Table 18, it is observed that Battery K of the invention, in which the coating layer is formed on the surface of the negative electrode side of the separator main body and also LiBF₄ is added to the electrolyte solution, exhibited a greater remaining capacity (i.e., higher storage performance in a charged state) than Comparative Battery U1, in which LiBF₄ is added but no coating layer is formed on the surface of the separator main body, and Comparative Battery U2, in which no LiBF₄ is added to the electrolyte solution and no coating layer is formed on the surface of the separator main body.

The reason is believed to be the same as that discussed in the experiment of the Ninth Group of Examples. Specifically, the addition of LiBF₄ to the electrolyte solution exerts the effect of hindering the substances that constitute the positive electrode active material (such as Co ions and Mn ions) from dissolving away and the effect of hindering the electrolyte solution from decomposing on the positive electrode surface, and the formation of the coating layer on the surface of the separator main body exerts the filtering effect. Accordingly, it is understood that coating layer may be formed on the surface of the negative electrode side of the separator main body.

However, it is observed that the battery performance is higher when the coating layer is formed on the surface of the positive electrode side of the separator main body than when the coating layer is formed on the surface of the negative electrode side of the separator main body (the degree of improvement in the performance is greater in Battery J of the invention, as compared to Comparative Battery V2, than Battery K of the invention, as compared to Comparative Battery U1, shown in the Ninth Group of Examples). Therefore, it is preferable that coating layer be formed on the surface of the positive electrode side of the separator main body.

It should be noted that what has been described in “(4) Matters Relating to the Present Examples” in the Ninth Group of Examples can be applied to the present Group of Examples as well.

### Other Embodiments

### [a]Embodiments Particular to the Cases where an Organic Solvent is Used as the Solvent (the Cases where a Water-Insoluble Binder is Used as the Binder)

(1) Preferable examples of the materials of the water-insoluble binder are not limited to the copolymers containing acrylonitrile units, but may also include PTFE (polytetrafluoroethylene), PVDF (polyvinylidene fluoride), PAN (polyacrylonitrile), SBR (styrene-butadiene rubber), modified substances thereof, derivatives thereof, and polyacrylic acid derivatives. However, copolymers containing acrylonitrile units and polyacrylic acid derivatives are preferable in that they exhibit the effect of water-insoluble binder with a small amount.

(2) The coating layer does not need to be formed on both sides of the separator main body, but may be formed only on one side thereof. When the coating layer is formed on only one side of the separator, the battery capacity is prevented from reducing since the thickness of the separator becomes smaller. When the coating layer is formed on only one side of the separator main body, it is desirable that the coating layer be formed on the positive electrode side of the separator main body so that the trapping effect can be enhanced.

### [b] Embodiments Particular to the Cases where Water is Used as the Solvent (the Cases where the Binder Contains a Water-Insoluble Binder and a Water-Soluble Binder)

(1) Preferable examples of the materials of the water-insoluble binder are not limited to the copolymers containing an acrylonitrile unit. Desirable examples include other fluorine-free polymers such as acrylic polymers, nitrile-based polymers, diene-based polymers, and copolymers thereof. Although it is possible to use a fluorine-containing polymer such as PVDF and PTFE, it is desirable to use a fluorine-free polymer, particularly an acrylic polymer, in order to sufficiently obtain its functions, namely, good binding strength that can be achieved even with a small amount and high flexibility. Additionally, it is desirable that the amount of the water-insoluble polymer added be 10 mass % or less with respect to the total amount of solid content (the total amount of the particles that form the porous layer, i.e., in the above embodiments, the total amount of the filler particles, the water-insoluble binder, the water-soluble binder, and the surfactant), more preferably 5 mass % or less, and still more preferably 3 mass % or less. It is desirable that the amount of the water-insoluble polymer be 0.5 mass % or greater in order to exert the binding performance sufficiently. It should be noted that since the coating layer is disposed on the negative electrode side of the separator main body, the coating layer does not make contact directly with the positive electrode. Therefore, it is not necessary to take particular care for the stability against positive electrode potential. That said, it is undesirable to use a material that is known to decompose the positive electrode potential, such as SBR, which is electrochemically unstable at about 4.1 V.

(2) Examples of the water-soluble polymer include cellulose-based polymers such as CMC, ammonium salts thereof, alkali metal salts thereof, polyacrylic acid ammonium salts thereof, and polycarboxylic acid ammonium salts thereof. It is desirable that the amount of the water-soluble polymer added be 10 mass % or less, more preferably from 0.5 mass % to 3 mass %, with respect to the total amount of solid content.

(3) Although there are no particular limitations on the kind of the surfactant, it is preferable to use a nonionic surfactant, taking the adverse effect in the lithium-ion battery on the battery performance into consideration. It is also desirable that the amount of the surfactant added be 3 mass % or less, more preferably from 0.5 mass % to 1 mass %, with respect to the total amount of solid content.

(4) It is desirable that the total amount of solid content excluding the filler particles be 30 mass % or less with respect to the amount of the filler particles.

### [C] Other Embodiments Common to the Three Embodiments

(1) The positive electrode active material is not limited to lithium cobalt oxide. Other usable materials include lithium composite oxides containing cobalt or manganese, such as lithium cobalt-nickel-manganese composite oxide, lithium aluminum-nickel-manganese composite oxide, and lithium aluminum-nickel-cobalt composite oxide, as well as spinel-type lithium manganese oxides. Preferably, the positive electrode active material shows a capacity increase by being charged at a higher voltage than 4.3 V verses the potential of a lithium reference electrode, and preferably has a layered structure. Moreover, such positive electrode active materials may be used either alone or in combination with other positive electrode active materials.

(2) The method for mixing the positive electrode mixture is not limited to wet-type mixing techniques, and it is possible to employ a method in which a positive electrode active material and a conductive agent are dry-blended in advance, and thereafter PVDF and NMP are mixed and agitated together.

(3) The negative electrode active material is not limited to graphite as described above. Various other materials may be employed, such as coke, tin oxides, metallic lithium, silicon, and mixtures thereof, as long as the material is capable of intercalating and deintercalating lithium ions.

(4) The lithium salt in the electrolyte (or the lithium salt mixed with LiBF₄ in the case of the third embodiment) is not limited to LiPF₆, and various other substances may be used, including LiN(SO₂CF₃)₂, LiN(SO₂C₂F₅)₂, LiPF_{6-X}(CₙF₂ₙ₊₁)_{X} (wherein 1<x<6 and n=1 or 2), which may be used either alone or in combination. The concentration of the lithium salt is not particularly limited, but it is preferable that the concentration of the lithium salt be restricted in the range of from 0.8 moles to 1.5 moles per 1 liter of the electrolyte. The solvents for the electrolyte are not particularly limited to ethylene carbonate (EC) and diethyl carbonate (DEC) mentioned above, and preferable solvents include carbonate solvents such as propylene carbonate (PC), γ-butyrolactone (GBL), ethyl methyl carbonate (EMC), and dimethyl carbonate (DMC). More preferable is a combination of a cyclic carbonate and a chain carbonate.

(5) The present invention may be applied not only to liquid-type batteries but also to gelled polymer batteries. In this case, usable examples of the polymer materials include polyether-based solid polymer, polycarbonate-based solid polymer, polyacrylonitrile-based solid polymer, oxetane-based polymer, epoxy-based polymer, and copolymers or cross-linked polymers comprising two or more of these polymers, as well as PVDF. Any of the above examples of the polymer materials may be used in combination with a lithium salt and an electrolyte, to form a gelled solid electrolyte.

### INDUSTRIAL APPLICABILITY

The present invention is suitable for driving power sources for mobile information terminals such as mobile telephones, notebook computers, and PDAs, especially for use in applications that require a high capacity. The invention is also expected to be used for high power applications that require continuous operations under high temperature conditions, such as HEVs and power tools, in which the battery operates under severe operating environments.

### BRIEF DESCRIPTION OF THE DRAWINGS

FIG. 1 is a graph illustrating the relationship between potential and change in the crystal structure of lithium cobalt oxide.

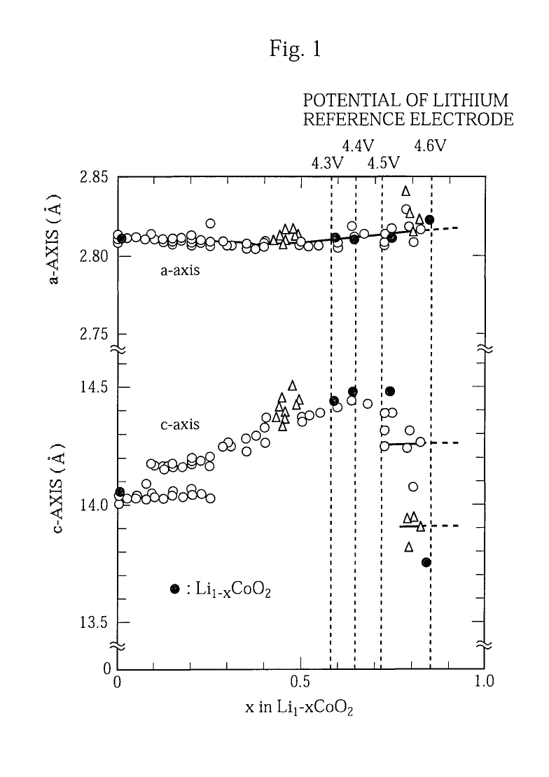

FIG. 2 is a graph illustrating the relationship between remaining capacities and separator pore volumes after storage in a charged state.

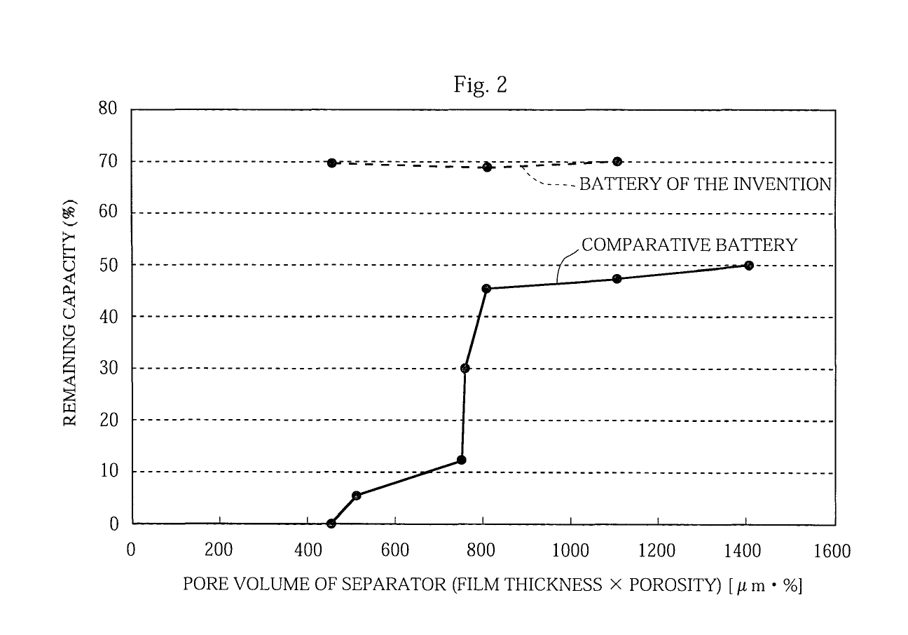

FIG. 3 is a graph illustrating the relationship between charge-discharge capacity and battery voltage in Comparative Battery Z2.

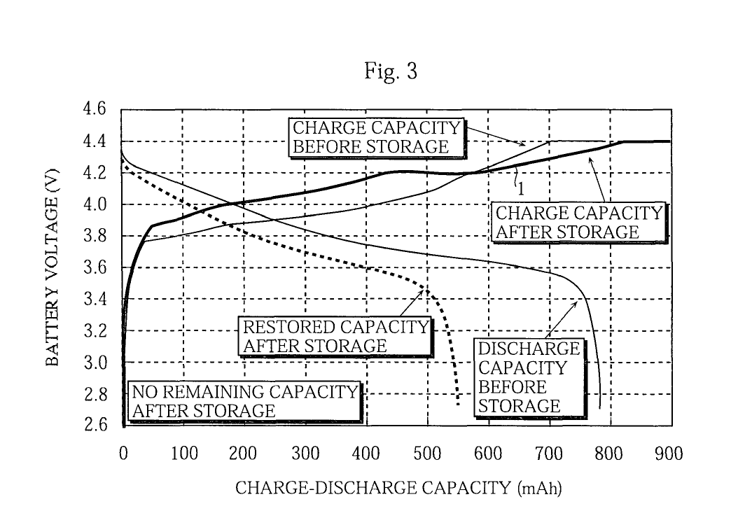

FIG. 4 is a graph illustrating the relationship between charge-discharge capacity and battery voltage in Battery A2 of the invention.

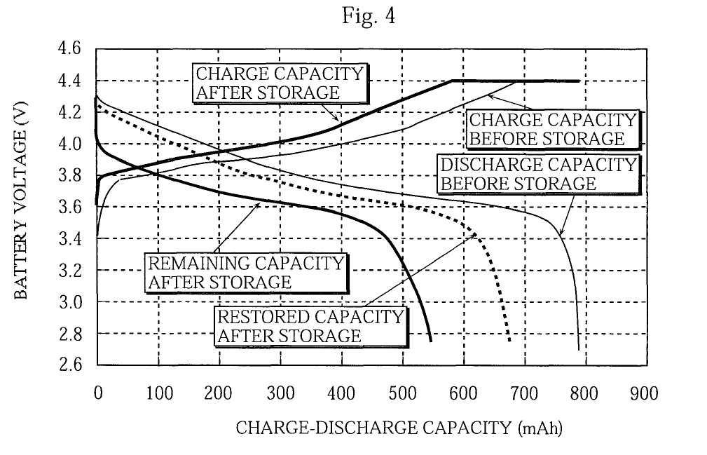

FIG. 5 is a graph illustrating the relationship between remaining capacities and separator pore volumes after storage in a charged state.

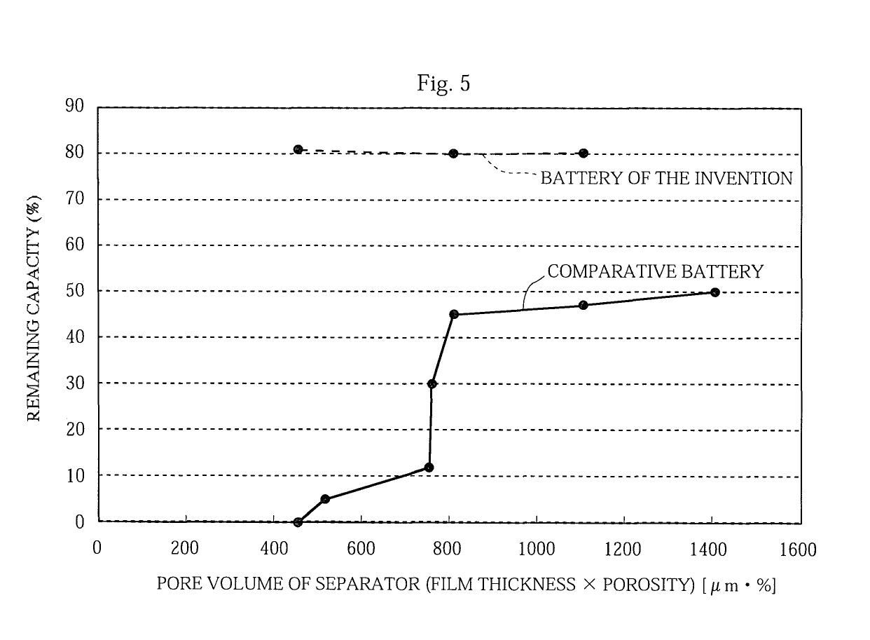

### DESCRIPTION OF REFERENCE NUMERALS

1 meandering portion

1. A non-aqueous electrolyte battery comprising: a positive electrode having a positive electrode active material layer containing a positive electrode active material; a negative electrode having a negative electrode active material; a separator interposed between the positive electrode and the negative electrode; an electrode assembly comprising the positive electrode, the negative electrode, and the separator; and a non-aqueous electrolyte impregnated in the electrode assembly, characterized in that:
the positive electrode active material contains at least cobalt or manganese; the separator comprises a porous separator main body and a coating layer formed on at least one surface of the separator main body, the coating layer comprising filler particles and a water-insoluble binder; and the positive electrode is charged to 4.40 V or higher versus a lithium reference electrode potential.

2. (canceled)

3. (canceled)

4. The non-aqueous electrolyte battery according to claim 1, wherein the positive electrode active material layer has a filling density of 3.40 g/cc or greater.

5. The non-aqueous electrolyte battery according to claim 1, wherein the concentration of the water-insoluble binder is 50 mass % or less with respect to the filler particles.

6. The non-aqueous electrolyte battery according to claim 1, wherein the water-insoluble binder comprises a copolymer containing an acrylonitrile unit and/or a polyacrylic acid derivative.

7. The non-aqueous electrolyte battery according to claim 1, wherein the coating layer contains a water-soluble binder, and the coating layer is formed on a surface of a negative electrode side of the separator main body.

8. The non-aqueous electrolyte battery according to claim 7, wherein the water-insoluble binder comprises a fluorine-free polymer, and the water-soluble binder comprises at least one substance selected from the group consisting of a cellulose-based polymer, an ammonium salt thereof, an alkali metal salt thereof, a polyacrylic acid ammonium salt thereof, and a polycarboxylic acid ammonium salt thereof.

9. The non-aqueous electrolyte battery according to claim 7, wherein the coating layer contains a surfactant.

10. The non-aqueous electrolyte battery according to claim 7, wherein the amount of the water-insoluble binder is 10 mass % or less with respect to the total amount of solid content.

11. The non-aqueous electrolyte battery according to claim 7, wherein the total amount of solid content excluding the filler particles is 30 mass % or less with respect to the amount of the filler particles.

12. The non-aqueous electrolyte battery according to claim 1, wherein the product of x and y, where x (μm) is the thickness of the separator main body and y is the porosity (%) of the separator main body, is 1500 (μm·%) or less.

13. (canceled)

14. The non-aqueous electrolyte battery according to claim 1, wherein the filler particles comprise inorganic particles.

15. The non-aqueous electrolyte battery according to claim 14, wherein the inorganic particles are made of a rutile-type titania and/or alumina.

16. (canceled)

17. The non-aqueous electrolyte battery according to claim 1, wherein the filler particles have an average particle size greater than the average pore size of the separator main body.

18. The non-aqueous electrolyte battery according to claim 1, wherein the coating layer has a thickness of 4 μm or less.

19. The non-aqueous electrolyte battery according to claim 1, wherein the positive electrode active material contains lithium cobalt oxide containing at least aluminum or magnesium in solid solution, and zirconia being electrically in contact with the lithium cobalt oxide is firmly attached on the surface of the lithium cobalt oxide.

20. The non-aqueous electrolyte battery according to claim 1, which may be used in an atmosphere at 50° C. or higher.

21. A non-aqueous electrolyte battery comprising: a positive electrode having a positive electrode active material layer containing a positive electrode active material; a negative electrode having a negative electrode active material; a separator interposed between the positive electrode and the negative electrode; an electrode assembly comprising the positive electrode, the negative electrode, and the separator; and a non-aqueous electrolyte impregnated in the electrode assembly, characterized in that:
the positive electrode active material contains at least cobalt or manganese; the separator comprises a porous separator main body and a coating layer formed on at least one surface of the separator main body, the coating layer comprising filler particles and a water-insoluble binder; and the positive electrode has a filling density of 3.40 g/cc or greater.

22. (canceled)

23. (canceled)

24. (canceled)

25. (canceled)

26. (canceled)

27. (canceled)

28. (canceled)

29. The non-aqueous electrolyte battery according to claim 21, wherein the product of x and y, where x (μm) is the thickness of the separator main body and y is the porosity (%) of the separator main body, is 1500 (μm·%) or less.

30. (canceled)

31. (canceled)

32. (canceled)

33. (canceled)

34. (canceled)

35. (canceled)

36. (canceled)

37. (canceled)

38. A non-aqueous electrolyte battery comprising: a positive electrode having a positive electrode active material layer containing a positive electrode active material; a negative electrode; a separator interposed between the positive electrode and the negative electrode; an electrode assembly comprising the positive electrode, the negative electrode, and the separator; and a non-aqueous electrolyte comprising a solvent and a lithium salt, the non-aqueous electrolyte being impregnated in the electrode assembly, characterized in that:
the positive electrode active material contains at least cobalt or manganese; a coating layer containing inorganic particles and a binder is formed on a surface of a positive electrode side of the separator and/or on a surface of a negative electrode side of the separator; the lithium salt comprises LiBF₄; and the positive electrode is charged to 4.40 V or higher versus a lithium reference electrode potential.

39-54. (canceled)

55. A method of manufacturing a non-aqueous electrolyte battery, comprising the steps of:
preparing a separator by coating a slurry containing filler particles, a water-insoluble binder, a water-soluble binder, and water onto at least one surface of a porous separator main body and drying the slurry to form a coating layer on the one surface of the separator main body;
preparing an electrode assembly by interposing the separator between a positive electrode and a negative electrode so that the coating layer is disposed on a negative electrode side of the separator, the positive electrode having a positive electrode active material layer comprising a positive electrode active material containing at least lithium and either cobalt or manganese, and the negative electrode having a negative electrode active material; and
impregnating the electrode assembly with a non-aqueous electrolyte.

56. (canceled)

57. (canceled)

58. The non-aqueous electrolyte battery according to claim 1, wherein the lithium salt comprises LiBF₄.
